(19) United States
(12) Patent Application Publication
(10) Pub. No.: US 2025/0266002 A1
(43) Pub. Date: Aug. 21, 2025

(54) GATE DRIVING CIRCUIT AND DISPLAY DEVICE INCLUDING THE SAME

(71) Applicant: LG DISPLAY CO., LTD., Seoul (KR)

(72) Inventors: Byung Hyun LEE, Paju-si (KR); Dae Young SEO, Paju-si (KR); Min Seok KIM, Paju-si (KR); Tae Yong KIM, Paju-si (KR); Su Min LEE, Paju-si (KR)

(73) Assignee: LG DISPLAY CO., LTD., Seoul (KR)

(21) Appl. No.: 18/979,175

(22) Filed: Dec. 12, 2024

(30) Foreign Application Priority Data
Feb. 16, 2024 (KR) 10-2024-0022482

(51) Int. Cl. G09G 3/3266; G09G 3/20; G09G 3/32

(52) U.S. Cl. CPC G09G 3/3266; G09G 3/2007; G09G 3/32; G09G 2300/0842; G09G 2310/027; G09G 2310/0286; G09G 2310/08; G09G 2320/0247; G09G 2320/043; G09G 2330/021

(57) ABSTRACT

A gate driving circuit for a display device can include a first pulse output part configured to output a first pulse of a scan signal through an output node, and a second pulse output part configured to output a second pulse of the scan signal through the output node. Also, the first pulse output part includes a first output transistor having a gate electrode connected to a first control node, and a second output transistor having a gate electrode connected to a second control node. Further, the second pulse output part includes a third control node, and a third output transistor connected to the third control node, and the second pulse output part is connected to the second control node and the output node of the first pulse output part.

### CROSS-REFERENCE TO RELATED APPLICATION

This application claims priority to and the benefit of Korean Patent Application No. 10-2024-0022482, filed in the Republic of Korea, on Feb. 16, 2024, the entirety of which is incorporated herein by reference into the present application.

### BACKGROUND

### Field

The present disclosure relates to a gate driving circuit and a display device including the same.

### Description of Related Art

Various flat display devices, such as liquid crystal display devices and electroluminescent display devices, can be used to display information. The electroluminescent display device is capable of displaying an input image by emitting light by itself without a backlight using a light-emitting element disposed in each of the pixels. Light-emitting elements of the electroluminescent display device can be categorized as an organic light-emitting element and an inorganic light-emitting element according to materials of light-emitting layers.

The electroluminescent display device can drive pixels by applying a light-emitting duty driving method that adjusts a duty ratio of each of the pixels. To do this, the pixel circuit of the electroluminescent display device uses a transistor that switches a current flowing to the light-emitting element in response to the light-emitting signal (or EM signal), and an EM driving circuit that sequentially outputs the light-emitting signal on a pixel line basis to control the transistor.

Recently, display devices that use light-emitting diodes (LED), which are inorganic light-emitting elements, as the light-emitting elements of pixels have attracted attention as the next generation of display devices. Since the LEDs are made of inorganic materials, there is no need for a separate encapsulation layer to protect the organic material from moisture, and they are more reliable and have a longer lifetime than organic light-emitting diodes (OLED). The LEDs also have a fast light-up speed, excellent luminous efficiency, and are resistant to impact.

In a display device including micro-LEDs, an emission duty driving method can be applied to increase the efficiency of the micro-LEDs. However, the emission duty driving method acts as a major cause of a rapid increase in power consumption, as the current of a display panel can increase rapidly due to the instantaneous time for all pixel lines to emit light. In the duty driving method, flicker can be visible when the emission duty ratio of pixels is reduced.

Thus a need exists for a display device having a configuration that can allow for driving of the pixels on a rolling pixel line basis while also controlling a duty cycle of the pixels without having additional emission lines in the pixel circuit, in order to save space, prevent flicker and improve image quality, particularly during a low power driving mode.

### SUMMARY OF THE DISCLOSURE

The present disclosure is directed to solving the aforementioned needs and/or drawbacks.

The present disclosure provides a pixel circuit capable of improving charging rates of pixels without increasing a non-display area, and a display device including the same.

A task of the present disclosure is not limited to the above-mentioned object, and other tasks not mentioned will be clearly understood by those skilled in the art from the following description.

A gate driving circuit according to one embodiment of the present disclosure includes a first pulse output part for outputting a first pulse of a scan signal through an output node, and a second pulse output part for outputting a second pulse of the scan signal through the output node. The first pulse output part can include a first output transistor having a gate electrode connected to a first control node, and a second output transistor having a gate electrode connected to a second control node. The second pulse output part can include a third control node and a third output transistor connected to the third control node. The second pulse output part is connected to the second control node and the output node of the first pulse output part.

The first pulse of the scan signal can output through the output node and simultaneously a first carry signal can output through the output node, and then the second pulse of the scan signal can output through the output node and simultaneously a second carry signal can output through a second carry signal node.

The first pulse output part can further include a first transistor connected between a gate-on voltage node and the first control node and configured to be turned on in response to a gate-on voltage of a first start signal node, a second transistor connected between a gate-off voltage node and the first control node and configured to be turned on in response to a gate-on voltage of the second control node, a third transistor connected between the gate-on voltage node and the second control node and configured to be turned on in response to a gate-on voltage of a third clock node, and a fourth transistor connected between the second control node and the gate-off voltage node and configured to be turned on in response to a gate-on voltage of the first control node. The first output transistor can be connected between a first clock node and the output node and can output a first pulse of the scan signal when a voltage of the first clock node is the gate-on voltage while the first control node is charged with the gate-on voltage. The second output transistor can be connected between the output node and the gate-off voltage node and can be turned on in response to a gate-on voltage of the second control node. A first start signal or a first carry signal from a previous signal transmission part can input to the first start signal node.

The second pulse output part can further include a fifth transistor connected between the second control node and the gate-off voltage node and configured to be turned on in response to a gate-on voltage of a second start signal node, a sixth transistor connected between the third control node and the gate-on voltage node and configured to be turned on in response to a gate-on voltage of the second start signal node, a seventh transistor connected between the third control node and the gate-off voltage node and configured to be turned on in response to a gate-on voltage of the third carry signal node, and a fourth output transistor connected between the second carry signal node and a second clock node and configured to be turned on in response to a gate-on voltage of the third control node to output a pulse of the second carry signal through the second carry signal node. The third output transistor can be connected between the second clock node and the output node and can be turned on in response to a gate-on voltage of the third control node to output a second pulse of the scan signal. A second start signal or a second carry signal from the previous signal transmission part can be input to the second start signal node. A second carry signal from the next signal transmission part can be input to the third carry signal node.

The first pulse output part can further include an eighth transistor and a ninth transistor connected in series between the first transistor and the first control node, a tenth transistor and a thirteenth transistor connected in series between the first control node and the gate-off voltage node, an eleventh transistor connected between the first control node and the second transistor, a twelfth transistor connected between the first control node and a gate electrode of the fourth transistor, and a fourteenth transistor connected between the gate-on voltage node and the second control node.

The eighth transistor can be connected between the first transistor and the ninth transistor and can be turned on in response to a gate-on voltage of a fourth clock node. The ninth transistor can be connected between the eighth transistor and the first control node. Each of the ninth transistor, the tenth transistor, the eleventh transistor, and the twelfth transistor can be turned on in response to a gate-on voltage applied to the gate-on voltage node. The thirteenth transistor can be connected between the tenth transistor and the gate-off voltage node and can be turned on in response to a gate-on voltage of a reset signal node. The fourteenth transistor can be connected between the gate-on voltage node and the second control node and can be turned on in response to a gate-on voltage of the reset signal node.

The first pulse output part can further include a sixteenth transistor connected between the second control node and the gate-off voltage node and configured to be turned on in response to a gate-on voltage of the first start signal node, and a seventeenth transistor connected between the gate-on voltage node and the second control node and configured to be turned on in response to a gate-on voltage of the third carry signal node.

The second pulse output part can further include a fifteenth transistor connected between the gate-off voltage node and the third control node and configured to be turned on in response to a gate-on voltage of the reset signal node.

A display device according to one embodiment of the present disclosure includes a display panel in which a plurality of data lines, a plurality of gate lines, and a plurality of pixel circuits are disposed, a data driver configured to supply a pixel grayscale voltage and a black grayscale voltage to the data lines, and a gate driver configured to supply a scan signal to the gate lines. The gate driver includes a plurality of signal transmission parts connected to a plurality of clock wires. An n-th signal transmission part (n is a natural number) includes a first pulse output part that outputs a first pulse of the scan signal, and a second pulse output part that outputs a second pulse of the scan signal. Each of the pixel circuits includes a driving transistor including a gate electrode connected to a first node, a first electrode connected to a second node, and a second electrode to which a ground voltage is applied, a light-emitting element including an anode electrode to which a pixel driving voltage is applied, and a cathode electrode connected to the second node, a first switching transistor connected between the data line and the first node and configured to be turned on in response to each of the first pulse and the second pulse of the scan signal, a second switching transistor connected between a power line to which a reference voltage is applied and the second node and configured to be turned on in response to each of the first pulse and the second pulse of the scan signal, and a capacitor connected between the first node and the second node.

The pixel grayscale voltage can be applied to the first node through the data line when the first pulse of the scan signal is input to the gate electrodes of the first and second switching transistors, and then the black grayscale voltage can be applied to the first node when the second pulse of the scan signal is input to the gate electrodes of the first and second switching transistors.

The first pulse output part can output a first pulse of the scan signal through an output node and simultaneously output a first carry signal through the output node, and then output a second pulse of the scan signal through the output node and simultaneously output a second carry signal through a second carry signal node.

The first pulse output part can include a first transistor connected between a gate-on voltage node and a first control node and configured to be turned on in response to a gate-on voltage of a first start signal node, a second transistor connected between a gate-off voltage node and the first control node and configured to be turned on in response to a gate-on voltage of a second control node, a third transistor connected between the gate-on voltage node and a second control node and configured to be turned on in response to a gate-on voltage of an (n+2)-th clock input to a third clock node, a fourth transistor connected between the second control node and the gate-off voltage node and configured to be turned on in response to a gate-on voltage of the first control node, a first output transistor connected between the first clock node and the output node and configured to be turned on when a voltage of a n-th clock input to the first clock node is a gate-on voltage while the first control node is charged with the gate-on voltage to output a first pulse of the scan signal, and a second output transistor connected between the output node and the gate-off voltage node and configured to be turned on in response to the gate-on voltage of the second control node. A first start signal or a first carry signal from a previous signal transmission part can be input to the first start signal node.

The second pulse output part can further include a fifth transistor connected between the second control node and the gate-off voltage node and configured to be turned on in response to a gate-on voltage of a second start signal node, a sixth transistor connected between a third control node and the gate-on voltage node and configured to be turned on in response to a gate-on voltage of the second start signal node, a seventh transistor connected between the third control node and the gate-off voltage node and configured to be turned on in response to a gate-on voltage of a third carry signal node, a third output transistor connected between a second clock node and the output node and configured to be turned on in response to the gate-on voltage of the third control node to output a second pulse of the scan signal by supplying a gate-on voltage of an (n−1)-th clock or an (n+1)-th clock input to the output node, and a fourth output transistor connected between the second carry signal node and the second clock node and configured to be turned on in response to a gate-on voltage of a third control node to output a pulse of a second carry signal through the second carry signal node. A second start signal or a second carry signal from the previous signal transmission part can be input to the second start signal node. A second carry signal from a next signal transmission part can be input to the third carry signal node.

The first pulse output part can further include an eighth transistor connected between the first transistor and the first control node and configured to be turned on in response to a gate-on voltage of a fourth clock node, a ninth transistor connected between the eighth transistor and the first control node, a tenth transistor connected between the first control node and the gate-off voltage node, an eleventh transistor connected between the first control node and the gate-off voltage node, a twelfth transistor connected between the first control node and a gate electrode of the fourth transistor, a thirteenth transistor connected between the tenth transistor and the gate-off voltage node and configured to be turned on in response to a gate-on voltage of a reset signal node, a fourteenth transistor connected between the gate-on voltage node and the second control node and configured to be turned on in response to a gate-on voltage of the reset signal node, a sixteenth transistor connected between the second control node and the gate-off voltage node and configured to be turned on in response to a gate-on voltage of the start signal node, and a seventeenth transistor connected between the gate-on voltage node and the second control node and configured to be turned on in response to a gate-on voltage of the third carry signal node. Each of the ninth transistor, the tenth transistor, the eleventh transistor, and the twelfth transistor can be turned on in response to a gate-on voltage applied to the gate-on voltage node.

The second pulse output part can further include a fifteenth transistor connected between the gate-off voltage node and the third control node to be turned on in response to a gate-on voltage of the reset signal node.

A voltage applied to the first node can be changed from the black grayscale voltage to the pixel grayscale voltage during a first pulse width period of the scan signal. The voltage applied to the first node can be changed from the pixel grayscale voltage to the black grayscale voltage during a second pulse width period of the scan signal.

A difference between the pixel driving voltage and the reference voltage can be smaller than a threshold voltage of the light-emitting element.

According to an embodiment of the present disclosure, it is possible to improve lifetime and low power driving by driving pixels with high efficiency and high luminance, and it is possible to improve a charging rate of pixels without increasing the non-display area because the number of clock wires input to a gate driving circuit can be reduced.

According to embodiments of the present disclosure, it is possible to drive the emission duty of pixels without adding a light-emitting signal (or EM signal), thereby enabling the emission duty driving in display panels where it is difficult to add the light-emitting signal.

According to an embodiment of the present disclosure, because the sub-pixels of all pixel lines do not emit light simultaneously, flicker is not visible and excessive current does not flow in the display panel.

The effects of the present disclosure are not limited to the above-mentioned effects, and other effects that are not mentioned will be apparently understood by those skilled in the art from the following description and the appended claims.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, in which:

FIG. 1 is a block diagram illustrating a display device according to an embodiment of the present disclosure;

FIG. 2 is a circuit diagram illustrating a pixel circuit according to an embodiment of the present disclosure;

FIG. 3 is a waveform diagram illustrating a data signal and a scan signal input to the pixel circuit shown in FIG. 2 according to an embodiment of the present disclosure;

FIG. 4 is a view illustrating one example of an emission duty driving method according to an embodiment of the present disclosure;

FIG. 5 is a view schematically illustrating a configuration of a gate driver according to an embodiment of the present disclosure;

FIG. 6 is a view schematically illustrating a configuration of a gate driver according to another embodiment of the present disclosure;

FIG. 7 is a circuit diagram illustrating one example of a n-th signal transmission part shown in FIG. 6 according to an embodiment of the present disclosure;

FIG. 8 is a circuit diagram illustrating another example of a n-th signal transmission part shown in FIG. 6 according to an embodiment of the present disclosure;

FIGS. 9A to 18B are diagrams illustrating the operation of the signal transmission part shown in FIG. 8 in time series according to embodiments of the present disclosure; and

FIGS. 19A and 19B are diagrams illustrating simulation results for verifying the operation and effect of the signal transmission part shown in FIG. 8 according to an embodiment of the present disclosure.

### DETAILED DESCRIPTION OF THE EMBODIMENTS

The advantages and features of the present disclosure and methods for accomplishing the same will be more clearly understood from embodiments described below with reference to the accompanying drawings. However, the present disclosure is not limited to the following embodiments but can be implemented in various different forms. Rather, the present embodiments will make the disclosure of the present disclosure complete and allow those skilled in the art to completely comprehend the scope of the present disclosure. The present disclosure is only defined within the scope of the accompanying claims.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present specification. Further, in describing the present disclosure, detailed descriptions of known related technologies can be omitted to avoid unnecessarily obscuring the subject matter of the present disclosure.

The terms such as “comprising,” “including,” “having,” and “comprising” used herein are generally intended to allow other components to be added unless the terms are used with the term “only.” Any references to singular can include plural unless expressly stated otherwise.

Components are interpreted to include an ordinary error range even if not expressly stated.

When a positional or interconnected relationship is described between two components, such as “on top of,” “above,” “below,” “next to,” “connect or couple with,” “crossing,” “intersecting,” or the like, one or more other components can be interposed between them, unless “immediately” or “directly” is used.

When a temporal antecedent relationship is described, such as “after,” “following,” “next to,” “before,” or the like, it may not be continuous on a time base unless “immediately” or “directly” is used.

The terms “first,” “second,” and the like can be used to distinguish elements from each other, but the functions or structures of the components are not limited by ordinal numbers or component names in front of the components. Also, the term “can” includes all meanings and definitions of the term “may.”

The following embodiments can be partially or entirely bonded to or combined with each other and can be linked and operated in technically various ways. The embodiments can be carried out independently of or in association with each other.

The pixel circuit of the display device can include a plurality of transistors. A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the situation of an n-channel transistor, since carriers are electrons, a source voltage is a voltage lower than a drain voltage such that electrons can flow from a source to a drain. The n-channel transistor has a direction of a current flowing from the drain to the source. In the situation of a p-channel transistor (p-channel metal-oxide semiconductor (PMOS)), since carriers are holes, a source voltage is higher than a drain voltage such that holes can flow from a source to a drain. In the p-channel transistor, since holes flow from the source to the drain, current flows from the source to the drain. It should be noted that a source and a drain of a transistor are not fixed. For example, a source and a drain can be changed according to an applied voltage. Therefore, the disclosure is not limited to a source and a drain of a transistor. In the following description, a source and a drain of a transistor will be referred to as a first electrode and a second electrode.

A gate signal swings between a gate-on voltage and a gate-off voltage. A transistor is turned on in response to a gate-on voltage and is turned off in response to a gate-off voltage. In the situation of an n-channel transistor, the gate-on voltage can be a gate high voltage VGH, and the gate-off voltage can be a gate low voltage VGL. In the situation of a p-channel transistor, the gate-on voltage can be the gate low voltage VGL, and the gate-off voltage can be the gate high voltage VGH.

Hereinafter, various embodiments of the present disclosure will be described in detail with reference to the accompanying drawings.

Referring to FIG. 1, a display device according to one embodiment of the present disclosure includes a display panel 100, a display panel driving circuit for writing pixel data to pixels 101 of the display panel 100, and a power supply 140 for generating power used for driving the pixels 101 and the display panel driving circuit.

A substrate of the display panel 100 can be, but is not limited to, a plastic substrate, a thin glass substrate, or a metal substrate. The display panel 100 can be, but is not limited to, a rectangular shaped panel having a length in the X-axis direction (or first direction), a width in the Y-axis direction (or second direction), and a thickness in the Z-axis direction (or third direction). For example, at least some portions of the display panel 100 can have a curved outer portion.

The display panel 100 can be implemented as a non-transmissive display panel or a transmissive display panel. The transmissive display panel (or transparent display panel) can be applied to a transparent display device in which an image is displayed on a screen and an actual image is visible beyond the display panel 100 through a light transmitting area of each of the pixels 101. The display panel 100 can be made as a flexible display panel. The display panel 100 can be made of a stretchable panel that can be stretched. For the transparent display device and the stretchable panels, it is desirable to minimize the number of wires and circuit elements connected to the pixel circuit.

A display area AA of the display panel 100 includes a pixel array for displaying an input image thereon. The pixel array includes a plurality of data lines 102, a plurality of gate lines 103 intersecting the data lines 102, and pixels 101 arranged in a matrix form. The display panel 100 can further include power lines commonly connected to the pixels 101. The power lines are commonly connected to the pixels and supply a constant voltage necessary for driving the pixels 101 to the pixels 101. The power lines can be implemented as long stripes of wires along either the first or second direction, or as mesh wires where the wires in the first direction and the wires in the second direction are electrically connected.

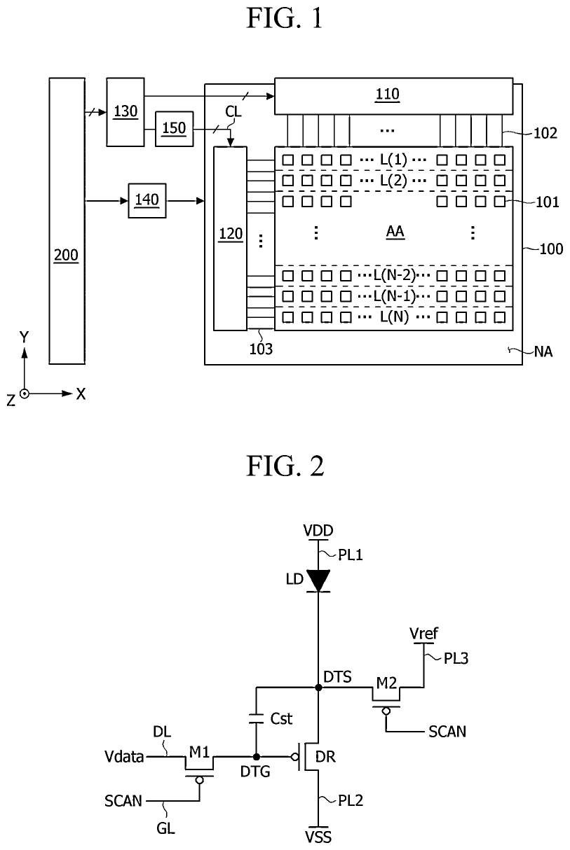

Each of the pixels 101 can be divided into a red sub-pixel, a green sub-pixel, and a blue sub-pixel for color implementation. Each of the pixels can further include a white sub-pixel. Each sub-pixel includes a pixel circuit for driving a light-emitting element. The pixel circuit can be implemented as a circuit shown in FIG. 2, but is not limited thereto. Hereinafter, a “pixel” can be interpreted as having the same meaning as a “sub-pixel.”

The pixel array includes a plurality of pixel lines L(1) to L(N). Where N is a natural number greater than or equal to 2. Each of the pixel lines L(1) to L(N) includes one line of pixels arranged along the line direction (X-axis direction) in the pixel array of the display panel 100. The pixels arranged in one pixel line can share a gate line 103. The sub-pixels arranged in the column direction (Y-axis direction) along a data line direction can share the same data line 102. One horizontal period is a time obtained by dividing one frame period by the total number of pixel lines L(1) to L(N).

The power supply 140 generates the constant voltages (or direct current (DC) voltages) required for driving the pixel array and the display panel driving circuit of the display panel 100 using a DC-DC converter. The DC-DC converter can include a charge pump, a regulator, a buck converter, a boost converter, and the like. The power supply 140 can adjust the level of the input voltage from a host system 200 to output constant voltages, such as a gamma reference voltage, a data driving voltage, a gate-low voltage, a gate-high voltage, a pixel driving voltage, a pixel ground voltage (hereinafter referred to as “ground voltage”), a pixel reference voltage (hereinafter referred to as “reference voltage”), and the like. The gamma reference voltage and the data driving voltage are supplied to the data driver 110. A dynamic range of the data voltage output from the data driver 110 is determined by a voltage range of the gamma reference voltage. The dynamic range of the data voltage is the range of voltages between the maximum voltage and the minimum voltage of a data voltage.

The gate-high voltage and the gate-low voltage are supplied to a level shifter 150 and the gate driver 120. The constant voltages such as the pixel driving voltage, the ground voltage, the reference voltage, and the like are supplied to the pixels 101 through the power lines commonly connected to the pixels 101. The reference voltage can be interpreted as the initialization voltage. The pixel driving voltage can be supplied from a main power source of the host system 200 to the display panel 100. In this situation, the power supply 140 does not need to output the pixel driving voltage.

The display panel driving circuit writes the pixel data of the input image to the pixels of the display panel 100 under the control of the timing controller 130. The display panel driving circuit includes the data driver 110 and the gate driver 120.

The display panel driving circuit can further include a touch sensor driver for driving touch sensors. The touch sensor driver is omitted from FIG. 1. The data driver 110 and the touch sensor driver can be integrated into one drive IC (Integrated Circuit). The timing controller 130, the power supply 140, the level shifter 150, the data driver 110, the touch sensor driver can be further integrated into the drive IC.

The data driver 110 receives the pixel data of the input image and black data received as a digital signal from the timing controller 130 and outputs a voltage of the data signal (hereinafter referred to as a “data voltage”). The data driver 110 converts the pixel data of the input image and the black data to a gamma compensation voltage using a digital-to-analog converter (DAC) to output the data voltage. The gamma reference voltage is divided into a grayscale-specific gamma compensation voltage by a voltage divider circuit in the data driver 110 and is supplied to the DAC. The DAC generates the data voltage as the gamma compensation voltage corresponding to the grayscale value of the pixel data. The data voltage output from the DAC is output to the data line 102 through the output buffer in each of the data output channels of the data driver 110.

The gate driver 120 can be formed in the display panel 100 together with a TFT array of the pixel array and the wires. The gate driver 120 can be disposed in the non-display area NA outside the display area AA in the display panel 100, or at least a portion thereof can be disposed in the display area AA. In the situation where the circuit of the gate driver 120 is disposed within the display area AA, the pixel circuits and the light-emitting elements of the pixels 101 can overlap in the Z-axis direction of the display panel 100.

The gate driver 120 can be disposed in either a left non-display area NA or a right non-display area NA outside the display area AA in the display panel 100 to supply the gate signal to the gate lines 103 in a single feeding method. In the single feeding method, the gate signal is applied to one ends of the gate lines. The gate driver 120 can be disposed in the left non-display area NA and the right non-display area NA in the display panel 100 to apply the gate signal to the gate lines 103 by a single feeding method or a double feeding method. In the double feeding method, the gate signal is applied simultaneously to both ends of the gate lines 103. At least some circuits of the gate driver 120 can be disposed within the display area AA.

The gate driver 120 can output the pulse of the scan signal twice or more times in each frame period under the control of the timing controller 130. The gate driver 120 can shift the pulse of the scan signal using a shift register and/or an edge trigger.

The timing controller 130 rearranges the pixel data of the input image and sends rearranged pixel data to the data driver 110. The timing controller 130 can add the black data stored in an embedded memory to the data stream of the pixel data and transmit the data stream to the data driver 110. The black data can be stored in an internal memory of the timing controller 130. The black data can be converted by the data driver 110 to a black grayscale voltage and output it to the data lines 102.

The timing controller 130 receives the pixel data of the input image and a timing signal synchronized with the pixel data from the host system 200. The timing signal can include a vertical synchronization signal Vsync, a horizontal synchronization signal Hsync, and a data enable signal DE. The vertical sync signal Vsync indicates one frame period including a pulse generated once every frame period. Pulses of the horizontal synchronization signal Hsync and the data enable signal DE can be one horizontal period (1H). The timing controller 130 can determine one frame period (or vertical period) and a horizontal period by counting the data enable signal DE. In this situation, the vertical synchronization signal Vsync and the horizontal synchronization signal Hsync can be omitted.

The timing controller 130 can control the operation timings of the data driver 110 and the gate driver 120 based on the timing signals Vsync, Hsync, and DE received from the host system 200. The gate timing signal can include a start signal and a clock to control the operation timing of the gate driver 120. The gate timing signal can further include a reset signal for resetting the gate driver 120. The gate timing control signal output from the timing controller 130 can be input to the gate driver 120 through the level shifter 150 and can be used to control the pulse of the gate signal output from the gate driver 120. The level shifter 150 can receive the gate timing control signal and generate the start signal and the clock to provide them to the gate driver 120. The input signal to the level shifter 150 is a signal of a digital signal voltage level. The start signal and the clock output from the level shifter 150 can swing between the gate-high voltage and the gate-low voltage. The start signal and the clock output from the level shifter 150 can be input to the gate driver 120 through a clock signal wire CL.

The host system 200 can scale an image signal from a video source to match the resolution of the display panel 100, and can transmit the scaled image signal to the timing controller 130 together with the timing control signal.

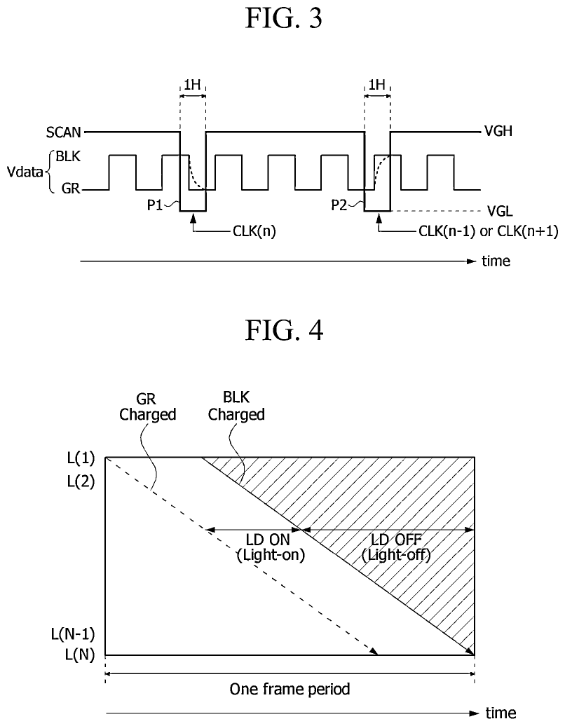

FIG. 2 is a circuit diagram illustrating a pixel circuit according to one embodiment of the present disclosure. FIG. 3 is a waveform diagram illustrating a data signal and a scan signal input to the pixel circuit illustrated in FIG. 2 according to an embodiment of the present disclosure. In FIG. 3, ‘1H’ denotes one horizontal period, and the dashed line represents the data voltage being charged in the sub-pixel. ‘VGL’ denotes the gate-on voltage of a scan signal SCAN) and ‘VGH’ is the gate-off voltage of the scan signal SCAN.

Referring to FIGS. 2 and 3, the pixel circuit can include a light-emitting element LD, a driving transistor DR, a first switching transistor M1, a second switching transistor M2, and a capacitor Cst. The driving transistor DR and each of the switching transistors M1 and M2 can be implemented as a p-channel transistor. The switching transistors M1 to M2 can be turned on in response to a pulse of a scan signal SCAN and turned off in response to a gate-off voltage of the scan signal SCAN. A pulse voltage of the scan signal SCAN is a gate-on voltage. The gate-on voltage can be a gate low voltage VGL, and the gate-off voltage can be a gate high voltage VGH. Hereinafter, the gate low voltage VGL will be referred to as the gate-on voltage, and the gate high voltage VGH will be referred to as the gate-off voltage.

The pixel circuit can be applied with a data voltage Vdata, a pixel driving voltage VDD, a ground voltage VSS, a reference voltage Vref, and the gate-off voltage VGH and the gate-on voltage VGL of the scan signal SCAN. An example of the voltage applied to the pixel circuit can be, but is not limited to, Vdata=3V to 7V, VDD=9V, VSS=0V, Vref=8V to 9V, VGH=13V, and VGL=−10V. The maximum voltage of the data voltage Vdata can be a black grayscale voltage, and the minimum voltage of the data voltage Vdata can be a peak white grayscale voltage.

The reference voltage Vref can be set to a constant voltage between 8V and 9V. A difference between the pixel driving voltage VDD and the reference voltage Vref can be set to a voltage less than a threshold voltage of the light-emitting element LD. Therefore, when the pixel driving voltage VDD is applied to an anode electrode of the light-emitting element LD and the reference voltage Vref is applied to a cathode electrode of the light-emitting element LD, the light-emitting element LD cannot emit light and is in a light-off state. The threshold voltage of the light-emitting element LD can be, but is not limited to, 1.5V.

The light-emitting element LD can include an anode electrode, a cathode electrode, and a light-emitting layer. The anode electrode of the light-emitting element LD can be connected to a first power line PL1 to which the pixel driving voltage VDD is applied. The cathode electrode of the light-emitting element LD can be connected to a second node DTS. The light-emitting element LD can be, but is not limited to, a light-emitting element such as OLED, mini-LED, micro-LED, and the like. In the situation of a mini LED or micro LED, it can be, but is not limited to, a vertical structure in which electrodes are disposed on the upper and lower portions of a semiconductor chip (Chip) on which light-emitting elements LDs are integrated. The semiconductor chip on which the light-emitting elements LDs are integrated can be implemented in a lateral structure or a flip-chip structure.

The light-emitting element LD and the driving transistor DR can be connected in series between the pixel driving voltage VDD and the ground voltage VSS.

The driving transistor DR drives the light-emitting element LD by adjusting a current flowing through a drain-source channel according to a gate-source voltage. The gate-source voltage of the driving transistor DR can be varied depending on a pixel grayscale voltage GR of the data voltage Vdata applied to the gate electrode of the driving transistor DR. Accordingly, the current flowing through the driving transistor DR is changed depending on the pixel grayscale voltage GR. The light-emitting element LD can emit light by a current from the driving transistor DR.

The driving transistor DR can be connected between the light-emitting element LD and the ground voltage VSS. The driving transistor DR includes a gate electrode connected to a first node DTG, a first electrode connected to a second node DTS, and a second electrode connected to a second power line PL2 to which the ground voltage VSS is applied. The capacitor Cst is connected between the first node DTG and the second node DTS to charge a gate-source voltage of the driving transistor DR and maintain the same for one frame period.

The first and second switching transistors M1 and M2 can be turned on in response to the gate-on voltage VGL of the scan signal SCAN, and can be turned on in response to the gate-off voltage VGH of the scan signal SCAN.

The first switching transistor M1 is connected between the data line DL, to which the data voltage Vdata is applied, and the first node DTG, and is turned on in response to a first pulse P1 and a second pulse P2 of the scan signal SCAN, which are successive every frame period. The pulse voltage of the scan signal is the gate-on voltage VGL. When the first switching transistor M1 is turned on, the data line DL can be electrically connected to the first node DTG. The first switching transistor M1 includes a first electrode connected to the data line DL, a gate electrode connected to the gate line GL to which the first pulse P1 and the second pulse P2 of the scan signal SCAN are applied, and a second electrode connected to the first node DTG.

The second switching transistor M2 is connected between a third power line PL3, to which the reference voltage Vref is applied, and the second node DTS and is turned on in response to the first pulse P1 and the second pulse P2 of the scan signal SCAN. When the second switching transistor M2 is turned on, the second node DTS can be electrically connected to the third power line PL3. The second switching transistor M2 includes a first electrode connected to the third power line PL3, a gate electrode connected to the gate line GL, and a second electrode connected to the second node DTS.

The data voltage Vdata includes a pixel grayscale voltage GR whose voltage level is varied according to a grayscale value of pixel data received as data from an input image, and a black grayscale voltage BLK, which is independent of the pixel data of the input image. The black grayscale voltage BLK can be the maximum voltage of the data voltage Vdata output from the data driver 110. When the black grayscale voltage BLK is applied to the gate electrode of the driving transistor DR, the driving transistor DR is turned off, preventing current from flowing to the light-emitting element LD. Accordingly, the sub-pixel to which the black grayscale voltage BLK is applied does not emit light and is therefore in the light-off state.

During the pulse width period of the first pulse P1 of the scan signal SCAN, the data voltage Vdata is changed from the black grayscale voltage BLK to the pixel grayscale voltage GR. Accordingly, during the pulse width period of the first pulse P1, the voltage of the first node DTG is initialized to the black grayscale voltage BLK and then the pixel grayscale voltage GR is charged. In this situation, the light-emitting element LD of the sub-pixel can emit light at a target luminance corresponding to the grayscale value of the pixel data.

During the pulse width period of the second pulse P2 of the scan signal SCAN, the data voltage Vdata is changed from the pixel grayscale voltage GR to the black grayscale voltage BLK. Accordingly, during the pulse width period of the second pulse P2, the voltage of the first node DTG is changed from the pixel grayscale voltage GR to the black grayscale voltage BLK. In this situation, the light-emitting element LD of the sub-pixel does not emit light because no current is generated from the driving transistor DR, so the sub-pixel displays a black grayscale that appears black.

FIG. 4 is a view illustrating one example of an emission duty driving method according to one embodiment of the present disclosure. In FIG. 4, ‘LD ON’ is a light-on period during which the light-emitting element LD can emit light, and ‘LD OFF’ is a light-off period during which the light-emitting element LD does not emit light.

Referring to FIGS. 3 and 4, the first pulse P1 of the scan signal SCAN is sequentially input to the gate lines GL of the display panel 100 for one frame period. As the first pulse P1 of the scan signal SCAN is sequentially shifted on a pixel line basis from the first pixel line L1 to the N-th pixel line L(N), which is the last pixel line, the pixel grayscale voltage GR can be charged in the sub-pixels. Subsequently, before the scan signal SCAN is input to the gate line GL of the last pixel line L(N), the second pulse P2 of the scan signal SCAN starts to be input from any one of the first to (n−1)-th pixel lines L(1) to L(N−1), and as the second pulse P2 of the scan signal SCAN is shifted to the last pixel line L(N), the black grayscale voltage BLK can be charged in the sub-pixels. Accordingly, in embodiment of the present disclosure, because the sub-pixels of all pixel lines do not emit light simultaneously, flicker is not visible and excessive current does not flow in the display panel 100. In addition, since the data voltage can be charged in the sub-pixels during one horizontal period 1H, the charging rate of the sub-pixels can be improved.

The gate driver 120 starts to output the first pulse P1 of the scan signal SCAN in response to a first start signal and a clock and shifts the first pulse P1 at the clock timing. The first pulse P1 of the scan signal SCAN sequentially selects sub-pixels charged with the pixel grayscale voltage GR on a pixel line basis. The gate driver 120 starts to output the second pulse P2 of the scan signal SCAN in response to a second start signal and a clock, and shifts the second pulse P2 at the clock timing. The second pulse P2 of the scan signal SCAN sequentially selects sub-pixels charged with the black grayscale voltage BLK on a pixel line basis.

The timing controller 130 can control the luminance of the pixels by controlling the emission duty ratio of each pixel based on the grays scale value of the pixel data. The timing controller 130 can change the luminance of each pixel to the grayscale value of the pixel data by controlling the timings of the first start signal and the second start signal input to the gate driver 120 using a gate timing signal input to a level shifter 150.

The emission duty ratio determines the pixel light-on/light-off ratio. When the first pulse P1 of the scan signal SCAN is sequentially shifted along the scan direction shown in FIG. 4, the light-emitting elements LD of the sub-pixels can emit light and the sub-pixels can be lit. When the second pulse P2 of the scan signal SCAN is sequentially shifted along the scan direction shown in FIG. 4, the light-emitting elements LD of the sub-pixels do not emit light so that the sub-pixels are in a light-off state (e.g., the sub-pixels are turned off by the second pulse P2). The first pulse P1 of the scan signal SCAN starts to be generated when the pulse of the first start signal is input to the gate driver 120, and the second pulse P2 of the scan signal SCAN starts to be generated when the pulse of the second start signal is input to the gate driver 120. Therefore, the greater the time difference between the first start signal and the second start signal, the greater the emission duty ratio, and thus the greater the luminance of the pixels, while the smaller the time difference between the first start signal and the second start signal, the smaller the emission duty ratio, and thus the lower the luminance of the pixels. In other words, the farther the first pulse P1 and the second pulse P2 are from each other, then the pixels stay on longer. Conversely, the closer the first pulse P1 and the second pulse P2 are to each other, then the pixels stay on for a shorter amount of time.

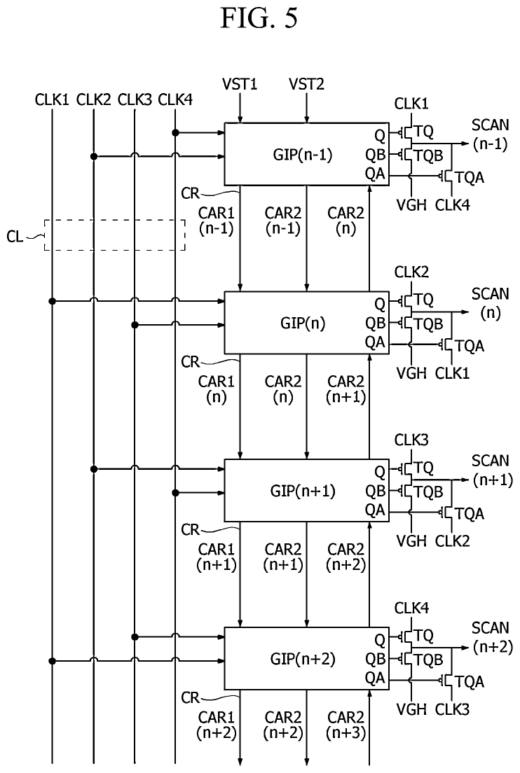

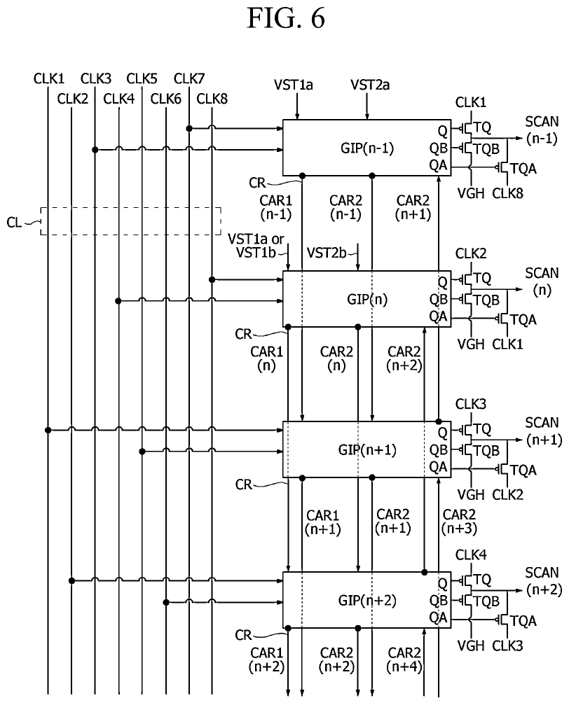

The gate driver 120 can include a plurality of signal transmission parts GIP(n−1) to GIP (n+1) which are dependently connected to each other via carry signal wires CL and carry signal wires CR, as shown in FIG. 5 or 6. The clocks input to the signal transmission parts GIP (n−1) to GIP(n+1) of the gate driver 120 can be an i-phase clock (i is a positive integer of 4 or more).

FIG. 5 is a diagram showing an example of the gate driver 120 to which 4-phase clocks CLK1 to CLK4 are input, and FIG. 6 is a diagram showing an example of the gate driver 120 to which 8-phase clocks CLK1 to CLK8 are input. In FIGS. 5 and 6, SCAN(n) is a scan signal applied to sub-pixels of the n-th pixel line.

FIG. 5 is a view schematically illustrating a configuration of a gate driver according to one embodiment of the present disclosure.

Referring to FIG. 5, the gate driver 120 includes the signal transmission parts GIP(n−1) to GIP(n+1) which are dependently connected to each other. Each of the signal transmission parts GIP(n−1) to GIP(n+1) can receive start signals VST1 and VST2 or carry signals CAR1 and CAR2 and the 4-phase clocks CLK1 to CLK4.

When the first start signal VST1 or the first carry signal CAR1(n−1)) from the previous signal transmission part is input to the n-th signal transmission part GIP(n), the n-th signal transmission part GIP(n) can output the first pulse P1 of the scan signal SCAN and the pulse of the first carry signal CAR1(n). The n-th signal transmission part GIP(n) can simultaneously output the first pulse P1 and the first carry signal CAR1(n) through a single output node or different output nodes. The first carry signal CAR1(n) output from the n-th signal transmission part GIP(n) can be input to a first VST node of the (n+1)-th signal transmission part GIP(n+1).

When the second start signal VST2 or the second carry signal CAR2(n−1) from the previous signal transmission part is input to the n-th signal transmission part GIP(n), the n-th signal transmission part GIP(n) can output the second pulse P2 of the scan signal SCAN and the pulse of the second carry signal CAR2(n). The n-th signal transmission part GIP(n) can simultaneously output the second pulse P2 and the second carry signal CAR2(n) through a single output node or different output nodes. The second carry signal CAR2(n) output from the n-th signal transmission part GIP(n) is input to a second VST node of the (n+1)-th signal transmission part GIP(n+1) and can be input to a third CAR node of the (n−1)-th signal transmission part GIP(n−1) at the same time.

Each of the signal transmission parts GIP(n−1) to GIP(n+1) includes a first control node Q for controlling a first output transistor TQ, a second control node QB for controlling a second output transistor TQB, and a third control node QA for controlling a third output transistor TQA.

The pulse timing of each of the first start signal VST1 and the second start signal VST2 can be controlled by the timing controller 130. The 4-phase clocks CLK1 to CLK4 are clocks in which the clock pulses are shifted sequentially in the order of CLK1, CLK2, CLK3, and CLK4. After CLK4, the clock pulse of CLK1 is generated again, followed by CLK2 and then the clock pulses are shifted in the order of CLK1, CLK2, and CLK3.

When the n-th clock is a second clock, the first control node Q of the n-th signal transmission part GIP(n) is charged with the gate-on voltage at the pulse timing of the (n−1)-th clock CLK1 and is activated, and when the pulse of the (n+1)-th clock CLK3 is input to the n-th signal transmission part GIP(n), the second control node QB of the n-th signal transmission part GIP(n) is discharged to the gate-off voltage and is deactivated. When the second start signal VST2 or the second carry signal CAR2(n−1) from the previous signal transmission part is input to the n-th signal transmission part GIP(n), the third control node QA is charged with the gate-on voltage and is activated, and the second control node QB is deactivated at the same time.

FIG. 6 is a view schematically illustrating a configuration of a gate driver according to another embodiment of the present disclosure.

Referring to FIG. 6, each of the signal transmission parts GIP(n−1) to GIP(n+1) can receive the start signals VST1 and VST2 or the carry signals CAR1 and CAR2 and the 8-phase clocks CLK1 to CLK8.

In FIG. 6, VST1a and VST1b represent first start signals that can be input to the first VST node of the signal transmission part. VST2a and VST2b represent second start signals that can be input to the second VST node of the signal transmission part. After the first start signal VST1b is input to the n-th signal transmission part GIP(n), the second start signal VST2a can be input to the second VST node of the (n−1)-th signal transmission part GIP(n−1). After the first start signal VST1a is input to the (n−1)-th signal transmission part GIP(n−1), the second start signal VST2a can be input to the second VST node of the (n−1)-th signal transmission part GIP (n−1). After the first start signal VST1a is input to the (n−1)-th signal transmission part GIP (n−1), the second start signal VST2b can be input to the second VST node of the n-th signal transmission part GIP(n).

When the first start signals VST1a and VST1b or the first carry signal CAR1(n−1) from the previous signal transmission part is input to the n-th signal transmission part GIP(n), the n-th signal transmission part GIP(n) can output the first pulse P1 of the scan signal SCAN and the pulse of the first carry signal CAR1(n). The n-th signal transmission part GIP(n) can simultaneously output the first pulse P1 and the first carry signal CAR1(n) through a single output node or different output nodes. The first carry signal CAR1(n) output from the n-th signal transmission part GIP(n) can be input to the first VST node of the (n+2)-th signal transmission part GIP(n+2).

When the second start signals VST2a and VST2b or the second carry signal from the (n−2)-th signal transmission part are input to the n-th signal transmission part GIP(n), the n-th signal transmission part GIP(n) can output the second pulse P2 of the scan signal SCAN and the pulse of the second carry signal CAR2(n). The n-th signal transmission part GIP(n) can simultaneously output the second pulse P2 and the second carry signal CAR2(n) through a single output node or different output nodes. The second carry signal CAR2(n) output from the n-th signal transmission part GIP(n) can be input to the second VST node of the (n+2)-th signal transmission part GIP(n+2) and can be input to the third CAR node of the n−2-th signal transmission part at the same time. When the second start signal VST2 or the second carry signal CAR(n−1) from the (n−1)-th signal transmission part is input to the (n+1)-th signal transmission part GIP(n+1), the (n+1)-th signal transmission part GIP(n+1) can output the second pulse P2 of the scan signal SCAN and the pulse of the second carry signal CAR2(n+1). The second carry signal CAR2(n+1) output from the (n+1)-th signal transmission part GIP(n+1) can be input to the second VST node of the (n−1)-th signal transmission part GIP(n−1) and can be input to the third CAR node of the (n+3)-th signal transmission part at the same time.

Each of the signal transmission parts GIP(n−1) to GIP(n+1) includes the first control node Q for controlling the first output transistor TQ, the second control node QB for controlling the second output transistor TQB, and the third control node QA for controlling the third output transistor TQA.

The pulse timing of each of the first start signals VST1a and VST1b and the second start signals VST2a and VST2b can be controlled by the timing controller 130. The 8-phase clocks CLK1 to CLK8 are clocks in which the clock pulses are shifted sequentially in the order of CLK1, CLK2, CLK3, CLK4, CLK5, CLK6, CLK7, and CLK8. After CLK8, the clock pulse of CLK1 is generated again, followed by CLK2 and then the clock pulses are shifted in the order of CLK1, CLK2, and CLK3.

When the n-th clock is a second clock, the first control node Q of the n-th signal transmission part GIP(n) is charged with the gate-on voltage at the pulse timing of the (n−2)-th clock CLK8 and is activated, and when the pulse of the (n+2)-th clock CLK4 is input to the n-th signal transmission part GIP(n), the second control node QB of the n-th signal transmission part GIP(n) is discharged to the gate-off voltage and is deactivated. When the second start signals VST2a and VST2b or the second carry signal from the previous signal transmission part is input to the n-th signal transmission part GIP(n), the third control node QA is charged with the gate-on voltage and is activated, and the second control node QB is deactivated at the same time.

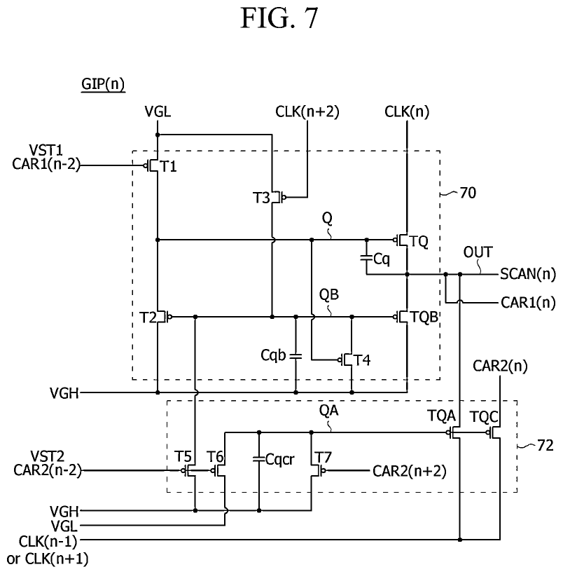

FIG. 7 is a circuit diagram illustrating one example of an n-th signal transmission part shown in FIG. 6. Other signal transmission parts other than the n-th signal transmission part can be implemented with substantially the same circuit as the n-th signal transmission part. The signal transmission parts shown in FIG. 7 are examples in which the 8-phase clocks are input as shown in FIG. 6.

Referring to FIG. 7, the signal transmission part GIP(n) includes a first pulse output part 70 and a second pulse output part 72. In this signal transmission part GIP(n), after the first pulse P1 of the scan signal SCAN(n) is output through an output node OUT and at the same time, the pulse of the first carry signal CAR1(n) is output through the output node OUT, the second pulse P2 of the scan signal SCAN(n) is output through the output node OUT, and at the same time, the pulse of the second carry signal CAR2(n) can be output through the second CAR node (or carry signal node).

The first pulse output part 70 outputs the first pulse P1 of the scan signal SCAN(n) through the output node OUT. The first pulse output part 70 can include a plurality of transistors T1 to T4, TQ, and TQB. Each of the transistors T1 to T4, TQ, TQ, and TQB can be implemented as, but is not limited to, a p-channel transistor.

The first transistor T1 can be connected between the VGL node and the first control node Q to be turned on in response to the gate-on voltage VGL of the first VST node. The gate-on voltage VGL is applied to the VGL node. The first start signal VST1 or the first carry signal CAR1(n−2) from the previous signal transmission part, e.g. the n−2-th signal transmission part, can be applied to the first VST node. When the first transistor T1 is turned on, the VGL node can be electrically connected to the first control node Q. The first transistor T1 includes a first electrode connected to the VGL node, a gate electrode connected to the first VST node, and a second electrode connected to the first control node Q.

The second transistor T2 can be connected between the first control node Q and the VGH node to be turned on when the voltage of the second control node QB is the gate-on voltage VGL. The gate-off voltage VGH is applied to the VGH node. When the second transistor T2 is turned on, the first control node Q can be electrically connected to the VGH node. The second transistor T2 includes a first electrode connected to the first control node Q, a gate electrode connected to the second control node QB, and a second electrode connected to the VGH node.

The third transistor T3 can be connected between the VGL node and the second control node QB to be turned on when the voltage of a third CLK node (or clock node) is the gate-on voltage VGL. The (n+2)-th clock CLK(n+2) can be applied to the third CLK node. When the third transistor T3 is turned on, the VGL node can be electrically connected to the second control node QB. The third transistor T3 includes a first electrode connected to the VGL node, a gate electrode connected to the third CLK node, and a second electrode connected to the second control node QB.

The fourth transistor T4 can be connected between the second control node QB and the VGH node to be turned on when the voltage of the first control node Q is the gate-on voltage VGL. When the fourth transistor T4 is turned on, the second control node QB can be electrically connected to the VGH node. The fourth transistor T4 includes a first electrode connected to the second control node QB, a gate electrode connected to the first control node Q, and a second electrode connected to the VGH node.

The first output transistor TQ is connected between the first CLK node and the output node OUT. The first output transistor TQ is turned on when the voltage of the first CLK node is the gate-on voltage VGL while the first control node Q is charged to the gate-on voltage VGL. When the first output transistor TQ is turned on, the voltage of the first CLK node can be applied to the output node OUT and the voltage of the scan signal SCAN(n) can be charged to the gate-on voltage VGL to output the first pulse P1. The n-th clock CLK(n) can be applied to the first CLK node. The pulse of the n-th clock CLK(n) is synchronized with the pixel grayscale voltage GR. Accordingly, when the first pulse P1 of the scan signal SCAN(n) is generated, the pixel grayscale voltage GR can be charged in the pixel circuit. The first output transistor TQ includes a first electrode connected to the first CLK node, a gate electrode connected to the first control node Q, and a second electrode connected to the output node OUT.

The second output transistor TQB is connected between the output node OUT and the VGH node to be turned on when the second control node QB is charged to the gate-on voltage VGL. When the second output transistor TQB is turned on, the output node OUT is electrically connected to the VGH node so that the voltage of the scan signal SCAN(n) is discharged to the gate-off voltage VGH. The second output transistor TQB includes a first electrode connected to the output node OUT, a gate electrode connected to the second control node QB, and a second electrode connected to the VGH node.

The first pulse output part 70 can further include a first capacitor Cq and a second capacitor Cqb. The first capacitor Cq is connected between the first control node Q and the output node OUT. When the first output transistor TQ is turned on and the gate-on voltage VGL of the first CLK node is applied to the output node OUT, bootstrapping occurs through the first capacitor Cq so that the voltage of the first control node Q can be boosted to a voltage higher than the gate-on voltage VGL. The second capacitor Cqb is connected between the second control node QB and the VGH node to suppress ripple of the second control node QB.

The second pulse output part 72 is connected to the second control node QB and the output node OUT of the first pulse output part 70 so that the second control node QB and the output node OUT of the first pulse output part 70 are shared with the second pulse output part 72. The second pulse output part 72 outputs the second pulse P2 of the scan signal SCAN(n) through the output node OUT using the third control node QA activated according to the voltage of the second VST node. The second pulse output part 72 can include a plurality of transistors T5, T6, T7, TQA, and TQC. Each of the transistors T5, T6, T7, TQA, and TQC can be implemented as, but is not limited to, a p-channel transistor.

The fifth transistor T5 can be connected between the second control node QB and the VGH node to be turned on in response to the gate-on voltage VGL of the second VST node. The second start signal VST2 or the second carry signal CAR2(n−2) from the previous signal transmission part, for example the n−2-th signal transmission part, can be applied to the second VST node. When the fifth transistor T5 is turned on, the second control node QB can be electrically connected to the VGH node. The fifth transistor T5 includes a first electrode connected to the second control node QB, a gate electrode connected to the second VST node, and a second electrode connected to the VGH node.

The sixth transistor T6 can be connected between the third control node QA and the VGL node to be turned on when the voltage of the second VST node is the gate-on voltage VGL. When the sixth transistor T6 is turned on, the third control node QA can be electrically connected to the VGL node. The sixth transistor T6 includes a first electrode connected to the third control node QA, a gate electrode connected to the second VST node, and a second electrode connected to the VGL node.

The seventh transistor T7 can be connected between the third control node QA and the VGH node to be turned on when the voltage of the second carry signal CAR2(n+2) from the next signal transmission part, for example the (n+2)-th signal transmission part, is the gate-on voltage VGL. When the seventh transistor T7 is turned on, the third control node QA can be electrically connected to the VGH node. The seventh transistor T7 includes a first electrode connected to the third control node QA, a gate electrode connected to the third CAR node to which the second carry signal CAR2(n+2) from the next signal transmission part is applied, and a second electrode connected to the VGH node. The third CAR node is connected to a carry wire to which the second carry signal CAR(n+2) from the next stage is applied.

The third output transistor TQA is connected between the second CLK node and the output node OUT. The third output transistor TQA can be turned on in response to the gate-on voltage VGL of the third control node QA. When the third output transistor TQA is turned on, the second CLK node is electrically connected to the output node OUT so that the second pulse P2 of the scan signal SCAN(n) can be output. An (n−1)-th clock CLK(n−1) or an (n+1)-th clock CLK(n+1) can be applied to the second CLK node. The pulse of the (n−1)-th clock CLK(n−1) is generated just before the pulse of the n-th clock CLK(n), and has a faster phase than the n-th clock CLK(n) and is synchronized with the black grayscale voltage BLK. The pulse of the (n+1)-th clock CLK(n+1) is generated just after the pulse of the n-th clock CLK(n), and has a slower phase than the n-th clock CLK(n) and is synchronized with the black grayscale voltage BLK. Accordingly, when the second pulse P2 of the scan signal SCAN(n) is generated, the pixel circuit can be charged with the black grayscale voltage BLK and the pixel can be turned off and stop emitting light.

The fourth output transistor TQC is connected between the second CAR node and the second CLK node to be turned on when the voltage of the second CLK node is the gate-on voltage VGL while the third control node QA is charged to the gate-on voltage VGL. When the fourth output transistor TQC is turned on, the second CLK node is electrically connected to the second CAR node so that the pulse of the second carry signal CAR2(n) can be output.

The third output transistor TQA includes a first electrode connected to the output node OUT, a gate electrode connected to the third control node QA, and a second electrode connected to the second CLK node. The fourth output transistor TQC includes a first electrode connected to the second CAR node, a gate electrode connected to the third control node QA, and a second electrode connected to the second CLK node.

The second pulse output part 72 can further include a third capacitor Cqcr. The third capacitor Cqcr is connected between the third control node QA and the VGH node.

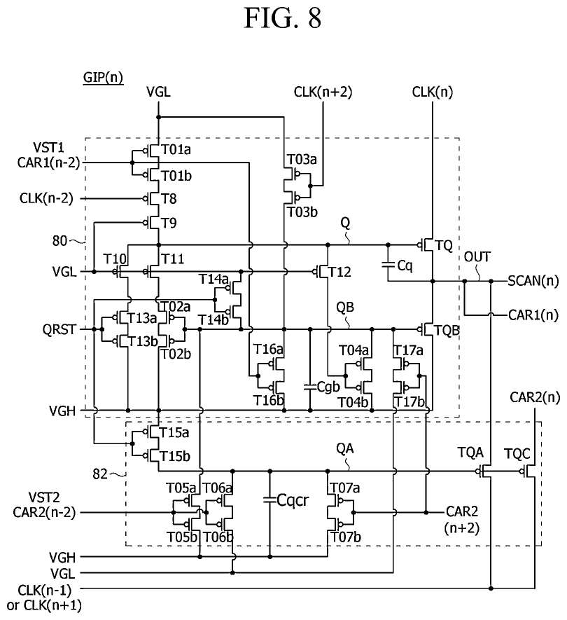

FIG. 8 is a circuit diagram illustrating another example of an n-th signal transmission part shown in FIG. 6. Other signal transmission parts other than the n-th signal transmission part can be implemented with substantially the same circuit as the n-th signal transmission part. The signal transmission parts shown in FIG. 8 are examples in which the 8-phase clocks are input as shown in FIG. 6.

Referring to FIG. 8, the signal transmission part GIP(n) includes a first pulse output part 80 and a second pulse output part 82. In this signal transmission part GIP(n), after the first pulse P1 of the scan signal SCAN(n) is output through an output node OUT and at the same time, the pulse of the first carry signal CAR1(n) is output through the output node OUT, the second pulse P2 of the scan signal SCAN(n) is output through the output node OUT, and at the same time, the pulse of the second carry signal CAR2(n) can be output through the second CAR node (or carry signal node).

The first pulse output part 80 outputs the first pulse P1 of the scan signal SCAN(n) through the output node OUT using a Q charging part, a Q discharging part, a QB charging part, and a QB discharging part. The first pulse output part 80 further includes a first output transistor TQ controlled by the voltage of the first control node Q, and a second output transistor TQB controlled by the voltage of the second control node QB. Each of the plurality of transistors TO1a to T04b, T8 to T14b, T16a to T17b, TQ, and TQB constituting the first pulse output part 80 can be implemented as, but is not limited to, a p-channel transistor.

The Q charging part activates the first control node Q by supplying the gate-on voltage VGL to the first control node Q in response to the gate-on voltage VGL of the first VST node and the fourth CLK node. The Q charging part includes the first transistors TO1a and TO1b, the eighth transistor T8, and the ninth transistor T9.

The first transistors TO1a and TO1b can be connected between the VGL node and the eighth transistor T8 to be turned on in response to the gate-on voltage VGL of the first VST node. The first start signal VST1 or the first carry signal CAR1(n−2) from the previous signal transmission part, for example the n−2-th signal transmission part, can be applied to the first VST node. When the first transistors TO1a and TO1b are turned on, the VGL node can be electrically connected to the first electrode of the eighth transistor T8. The first transistors TO1a and TO1b can include two transistors TO1a and TO1b connected in series between the VGL node and the first control node Q to reduce leakage current. The first-first transistor TO1a includes a first electrode connected to the VGL node, a gate electrode connected to the first VST node, and a second electrode connected to the first electrode of the first-second transistor T01b. The first-second transistor TO1b includes a first electrode connected to the second electrode of the first-first transistor TO1a, a gate electrode connected to the first VST node, and a second electrode connected to the first electrode of the eighth transistor T8.

The eighth and ninth transistors T8 and T9 can be connected in series between the first transistors TO1a and TO1b and the first control node Q. The eighth transistor T8 can be connected between the first-second transistor TO1b and the ninth transistor T9 to be turned on in response to the gate-on voltage VGL of the fourth CLK node. The n−2-th clock CLK(n−2) can be applied to the fourth CLK node. When the eighth transistor T8 is turned on, the second electrode of the first-second transistor TO1b can be electrically connected to the first electrode of the ninth transistor T9. The eighth transistor T8 includes a first electrode connected to the second electrode of the first-second transistor TO1b, a gate electrode connected to the fourth CLK node, and a second electrode connected to the first electrode of the ninth transistor T9.

The ninth transistor T9 can be connected between the eighth transistor T8 and the first control node Q to be turned on in response to the gate-on voltage VGL applied to the VGL node. When the ninth transistor T9 is turned on, the second electrode of the eighth transistor T8 can be electrically connected to the first control node Q. The ninth transistor T9 includes a first electrode connected to the second electrode of the eighth transistor T8, a gate electrode connected to the VGL node, and a second electrode connected to the first control node Q.

The Q discharging part electrically connects the first control node Q to the VGH node in response to a reset signal QRST and the gate-on voltage VGL of the second control node QB to discharge the voltage of the first control node Q to the gate-off voltage VGH. The Q discharging part includes the second transistors TO2a and TO2b, the tenth transistor T10, the eleventh transistor T11, and the thirteenth transistors T13a and T13b.

The tenth and thirteenth transistors T10, T13a, and T13b can be connected in series between the first control node Q and the VGH node. The tenth transistor T10 can be connected between the first control node Q and the thirteenth transistors T13a and T13b to be turned on in response to the gate-on voltage VGL applied to the VGL node. When the tenth transistor T10 is turned on, the first control node Q can be electrically connected to the thirteenth transistors T13a and T13b. The tenth transistor T10 includes a first electrode connected to the first control node Q, a gate electrode connected to the VGL node, and a second electrode connected to the first electrode of the thirteenth-first transistor T13a.

The eleventh transistor T11 can be connected between the first control node Q and the second transistors TO2a and TO2b to be turned on in response to the gate-on voltage VGL applied to the VGL node. When the eleventh transistor T11 is turned on, the first control node Q can be electrically connected to the second transistors T02a and T02b. The eleventh transistor T11 includes a first electrode connected to the first control node Q, a gate electrode connected to the VGL node, and a second electrode connected to the first electrode of the second-first transistor T02a.

The thirteenth transistors T13a and T13b can be connected between the tenth transistor T10 and the VGH node to be turned on in response to the gate-on voltage VGL of the reset signal QRST applied to the reset signal node. When the thirteenth transistors T13a and T13b are turned on, the tenth transistor T10 can be electrically connected to the VGH node. The thirteenth transistors T13a and T13b can include two transistors T13a and T13b connected in series to each other. The thirteenth-first transistor T13a includes a first electrode connected to the second electrode of the tenth transistor T10, a gate electrode connected to the reset signal node, and a second electrode connected to the first electrode of the thirteenth-second transistor T13b. The thirteenth-second transistor T13b includes a first electrode connected to the second electrode of the thirteenth-first transistor T13a, a gate electrode connected to the reset signal node, and a second electrode connected to the VGH node.

The reset signal QRST resets the first control node Q of the signal transmission parts when all the signal transmission parts of the gate driver 120 need to be reset. The reset signal QRST can be generated by the timing controller 130 to be simultaneously input to the signal transmission parts through the level shifter 150. The reset signal QRST can be generated just after the display device is powered on and during a vertical blank period between the N-th frame period and the (N+1)-th frame period.

The second transistors TO2a and TO2b can be connected between the eleventh transistor T11 and the VGH node to be turned on in response to the gate-on voltage VGL of the second control node QB. When the second transistors TO2a and TO2b are turned on, the eleventh transistor T11 can be electrically connected to the VGH node. The second transistors T02a and T02b can include two transistors T02a and TO2b connected in series to each other. The second-first transistor TO2a includes a first electrode connected to the second electrode of the 11th transistor T11, a gate electrode connected to the second control node QB, and a second electrode connected to the first electrode of the second-second transistor TO2b. The second-second transistor TO2b includes a first electrode connected to the second electrode of the second-first transistor TO2a, a gate electrode connected to the second control node QB, and a second electrode connected to the VGH node.

The QB charging part can activate the second control node QB by supplying the gate-on voltage VGL to the second control node QB in response to the gate-on voltage VGL of the reset signal node and the third CLK node. The QB charging part includes the third transistors T03a and TO3b, the fourteenth transistors T14a and T14b, and the seventeenth transistors T17a and T17b.

The third transistors T03a and TO3b can be connected between the VGL node and the second control node QB to be turned on when the voltage of the third CLK node is the gate-on voltage VGL. The (n+2)-th clock CLK(n+2) can be applied to the third CLK node. When the third transistors TO3a and TO3b are turned on, the VGL node is electrically connected to the second control node QB so that the second control node QB can be charged with the gate-on voltage VGL. The third transistors T03a and TO3b can include two transistors T03a and T03b connected in series to each other. The third-first transistor T03a includes a first electrode connected to the VGL node, a gate electrode connected to the third CLK node, and a second electrode connected to the first electrode of the third-second transistor TO3b. The third-second transistor TO3b includes a first electrode connected to the second electrode of the third-first transistor TO3a, a gate electrode connected to the third CLK node, and a second electrode connected to the second control node QB.

The fourteenth transistors T14a and T14b can be connected between the VGL node and the second control node QB to be turned on in response to the gate-on voltage VGL of the reset signal QRST applied to the reset signal node. When the fourteenth transistors T14a and T14b are turned on, the VGL node is electrically connected to the second control node QB so that the second control node QB can be charged with the gate-on voltage VGL. The fourteenth transistors T14a and T14b can include two transistors T14a and T14b connected in series to each other. The fourteenth-first transistor T14a includes a first electrode connected to the VGL node, a gate electrode connected to the reset signal node, and a second electrode connected to the first electrode of the fourteenth-second transistor T14a. The fourteenth-second transistor T14b includes a first electrode connected to the second electrode of the fourteenth-first transistor T14a, a gate electrode connected to the reset signal node, and a second electrode connected to the second control node QB.

The seventeenth transistors T17a and T17b can be connected between the VGL node and the second control node QB to be turned on in response to the gate-on voltage VGL applied to the third CAR node. The voltage of the second carry signal CAR2(n+2) from the next signal transmission part can be applied to the third CAR node. When the seventeenth transistors T17a and T17b are turned on, the VGL node is electrically connected to the second control node QB so that the second control node QB can be charged with the gate-on voltage VGL. The seventeenth transistors T17a and T17b can include two transistors T17a and T17b connected in series to each other. The seventeenth-first transistor T17a includes a first electrode connected to the second control node QB, a gate electrode connected to the third CAR node, and a second electrode connected to the first electrode of the seventeenth-second transistor T17b. The seventeenth-second transistor T17b includes a first electrode connected to the second electrode of the seventeenth-first transistor T17a, a gate electrode connected to the third CAR node, and a second electrode connected to the VGL node.

The QB discharging part deactivates the second control node QB by supplying the gate-off voltage VGH to the second control node QB in response to the gate-on voltage VGL of the first VST node and the first control node Q. The QB discharging part includes the fourth transistors T04a and TO4b, the twelfth transistor T12, and the sixteenth transistor T16a and T16B.

The twelfth transistor T12 can be connected between the first control node Q and the gate electrodes of the fourth transistors T04a and TO4b to be turned on in response to the gate-on voltage VGL applied to the VGL node. When the twelfth transistor T12 is turned on, the first control node Q can be electrically connected to the gate electrodes of the fourth transistors T04a and TO4b. The twelfth transistor T12 includes a first electrode connected to the first control node Q, a gate electrode connected to the VGL node, and a second electrode connected to the gate electrodes of the fourth transistors T04a and T04b.

The fourth transistors T04a and T04b can be connected between the second control node QB and the VGH node to be turned on in response to the gate-on voltage VGL of the first control node Q applied through the twelfth transistor T12. When the fourth transistors T04a and T04b are turned on, the VGH node is electrically connected to the second control node QB so that the second control node QB can be discharged to the gate-off voltage VGH. The fourth transistor T04a and T04b can include two transistors T04a and T04b connected in series to each other. The fourth-first transistor TO4a includes a first electrode connected to the second control node QB, a gate electrode connected to the second electrode of the twelfth transistor T12, and a second electrode connected to the first electrode of the fourth-second transistor T04b. The fourth-second transistor TO4b includes a first electrode connected to the second electrode of the fourth-first transistor TO4a, a gate electrode connected to the second electrode of the twelfth transistor T12, and a second electrode connected to the VGH node.

The sixteenth transistors T16a and T16b can be connected between the second control node QB and the VGH node to be turned on in response to the gate-on voltage VGL of the first VST node. When the sixteenth transistors T16a and T16b are turned on, the VGH node is electrically connected to the second control node QB so that the second control node QB can be discharged to the gate-off voltage VGH. The sixteenth transistor T16a and T16b can include two transistors T16a and T16b connected in series to each other. The sixteenth-first transistor T16a includes a first electrode connected to the second control node QB, a gate electrode connected to the first VST node, and a second electrode connected to the first electrode of the sixteenth-second transistor T16b. The sixteenth-second transistor T16b includes a first electrode connected to the second electrode of the sixteenth-first transistor T16a, a gate electrode connected to the first VST node, and a second electrode connected to the VGH node.

The first output transistor TQ is connected between the first CLK node and the output node OUT. The first output transistor TQ is turned on when the voltage of the first CLK node is the gate-on voltage VGL while the first control node Q is charged to the gate-on voltage VGL. When the first output transistor TQ is turned on, the voltage of the first CLK node can be applied to the output node OUT and the voltage of the scan signal SCAN(n) can be changed to the gate-on voltage VGL to output the first pulse P1. The n-th clock CLK(n) can be applied to the first CLK node. The pulse of the n-th clock CLK(n) is synchronized with the pixel grayscale voltage GR. Accordingly, when the first pulse P1 of the scan signal SCAN(n) is generated, the pixel grayscale voltage GR can be charged in the pixel circuit. The first output transistor TQ includes a first electrode connected to the first CLK node, a gate electrode connected to the first control node Q, and a second electrode connected to the output node OUT.

The second output transistor TQB is connected between the output node OUT and the VGH node to be turned on when the second control node QB is charged to the gate-on voltage VGL. When the second output transistor TQB is turned on, the output node OUT is electrically connected to the VGH node so that the voltage of the scan signal SCAN(n) is discharged to the gate-off voltage VGH. The second output transistor TQB includes a first electrode connected to the output node OUT, a gate electrode connected to the second control node QB, and a second electrode connected to the VGH node.

The first pulse output part 80 can further include a first capacitor Cq and a second capacitor Cgb. The first capacitor Cq is connected between the first control node Q and the output node OUT. The second capacitor Cgb is connected between the second control node QB and the VGH node.

The second pulse output part 82 outputs the second pulse P2 of the scan signal SCAN(n). The second pulse output part 82 can include a plurality of transistors T05a to T07a, T15a, T15b, TQA, and TQC. Each of the transistors TO5a to TO7a, T15a, T15b, TQA, and TQC can be implemented as, but is not limited to, a p-channel transistor.

The fifth transistors TO5a and TO5b can be connected between the second control node QB and the VGH node to be turned on in response to the gate-on voltage VGL of the second VST node. The second start signal VST2 or the second carry signal CAR2(n−2) from the previous signal transmission part can be applied to the second VST node. When the fifth transistors TO5a and TO5b are turned on, the second control node QB can be electrically connected to the VGH node. The fifth transistor TO5a and TO5b can include two transistors T05a and T05b connected in series to each other. The fifth-first transistor TO5a includes a first electrode connected to the second control node QB, a gate electrode connected to the second VST node, and a second electrode connected to the first electrode of the fifth-second transistor T05b. The fifth-second transistor TO5b includes a first electrode connected to the second electrode of the fifth-first transistor TO5a, a gate electrode connected to the second VST node, and a second electrode connected to the VGH node.

The sixth transistors TO6a and TO6b can be connected between the third control node QA and the VGL node to be turned on in response to the gate-on voltage VGL of the second VST node. When the sixth transistors TO6a and TO6b are turned on, the third control node QA can be electrically connected to the VGL node. The sixth transistors TO6a and T06b can include two transistors TO6a and TO6b connected in series to each other. The sixth-first transistor TO6a includes a first electrode connected to the third control node QA, a gate electrode connected to the second VST node, and a second electrode connected to the first electrode of the sixth-second transistor T06b. The sixth-second transistor TO6b includes a first electrode connected to the second electrode of the sixth-first transistor TO6a, a gate electrode connected to the second VST node, and a second electrode connected to the VGL node.

The seventh transistors T07a and TO7b can be connected between the third control node QA and the VGH node to be turned on in response to the gate-on voltage VGL of the third CAR node. The voltage of the second carry signal CAR2(n+2) of the next signal transmission part can be input to the third CAR node. When the seventh transistors TO7a and TO7b are turned on, the third control node QA can be electrically connected to the VGH node. The seventh transistors T07a and T07b can include two transistors TO7a and T07b connected in series to each other. The seventh-first transistor TO7a includes a first electrode connected to the third control node QA, a gate electrode connected to the third CAR node, and a second electrode connected to the first electrode of the seventh-second transistor TO7b. The seventh-second transistor TO7b includes a first electrode connected to the second electrode of the seventh-first transistor TO7a, a gate electrode connected to the third CAR node, and a second electrode connected to the VGH node.

The fifteenth transistors T15a and T15b can be connected between the VGH node and the third control node QA to be turned on in response to the gate-on voltage VGL of the reset signal QRST applied to the reset signal node. When the fifteenth transistors T15a and T15b are turned on, the VGH node can be electrically connected to the third control node QA. The fifteenth transistors T15a and T15b can include two transistors T15a and T15b connected in series to each other. The fifth-first transistor T15a includes a first electrode connected to the VGH node, a gate electrode connected to the reset signal node, and a second electrode connected to the first electrode of the fifth-second transistor T15b. The fifth-second transistor T15b includes a first electrode connected to the second electrode of the fifth-first transistor T15a, a gate electrode connected to the reset signal node, and a second electrode connected to the third control node QA.

The third output transistor TQA can be connected between the second CLK node and the output node OUT to be turned on in response to the gate-on voltage VGL of the third control node QA. When the third output transistor TQA is turned on, the voltage of the second CLK node is applied to the output node OUT so that the voltage of the scan signal SCAN(n) can be charged to the gate-on voltage VGL to output the second pulse P2. The (n−1)-th clock CLK(n−1) or the (n+1)-th clock CLK(n+1) can be applied to the second CLK node. The pulses of the (n−1)-th clock CLK(n−1) and the (n+1)-th clock CLK(n+1)) are synchronized with the black grayscale voltage BLK. Accordingly, when the second pulse P2 of the scan signal SCAN(n) is generated, the pixel circuit can be charged with the black grayscale voltage BLK.

The fourth output transistor TQC can be connected between the second CAR node and the second CLK node to be turned on in response to a gate-on voltage VGL of the third control node QA. When the fourth output transistor TQC is turned on, the second CLK node is electrically connected to the second CAR node so that a pulse of the second carry signal CAR2(n) can be output.

The third output transistor TQA includes a first electrode connected to the output node OUT, a gate electrode connected to the third control node QA, and a second electrode connected to the second CLK node. The fourth output transistor TQC includes a first electrode connected to the second CAR node, a gate electrode connected to the third control node QA, and a second electrode connected to the second CLK node.

The second pulse output part 82 can further include a third capacitor Cqcr. The third capacitor Cqcr is connected between the third control node QA and the VGH node.

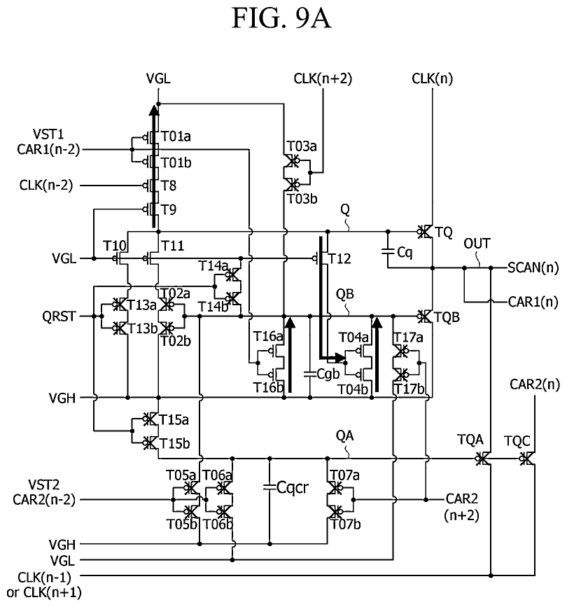

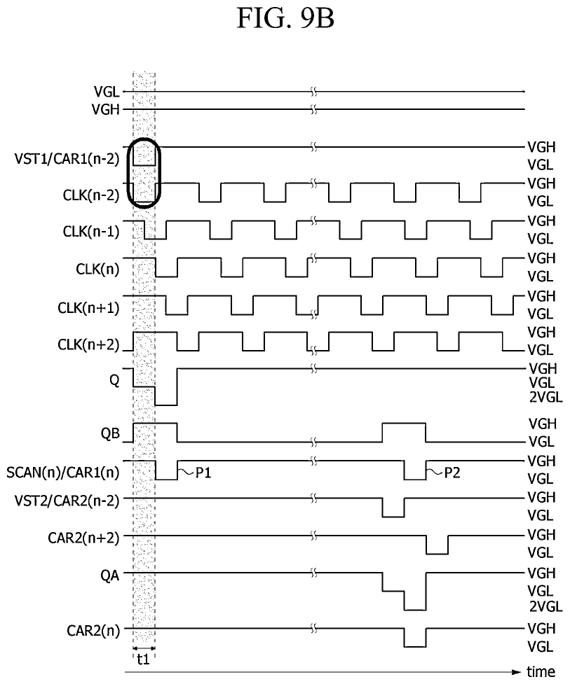

FIGS. 9A to 18B are diagrams illustrating the operation of the signal transmission part shown in FIG. 8 in time series according to an embodiment of the present disclosure. In FIGS. 9A to 18B, a transistor marked with ‘X’ represents a transistor in an off state. Transistors not marked with ‘X’ represent transistors in an on state.

Referring to FIGS. 9A and 9B, a voltage of a first start signal VST1 input to a first VST node or a first carry signal CAR1(n−2) from the previous signal transfer part during a period t1 is the gate-on voltage VGL. In this situation, the first transistors TO1a and TO1b, the eighth to twelfth transistors T8 to T12, the sixteenth transistors T16a and T16b, and the fourth transistors T04a and TO4b are turned on. The first control node Q is charged with the gate-on voltage VGL during the period t1, and the fourth transistors T04a and T04b are turned on in response to the gate-on voltage VGL of the first control node Q. The second control node QB is electrically connected to the VGH node through the fourth transistors T04a and TO4b and is discharged to the gate-off voltage VGH during the period t1.

During the period t1, an output node voltage of the signal transmission part is the gate-off voltage. Accordingly, the voltage of the scan signal SCAN applied to the pixel circuit shown in FIG. 2 during the period t1 is the gate-off voltage VGH. The first and second switching transistors M1 and M2, the driving transistor DR, and the light-emitting element LD of the pixel circuit are in an off state during the period t1.

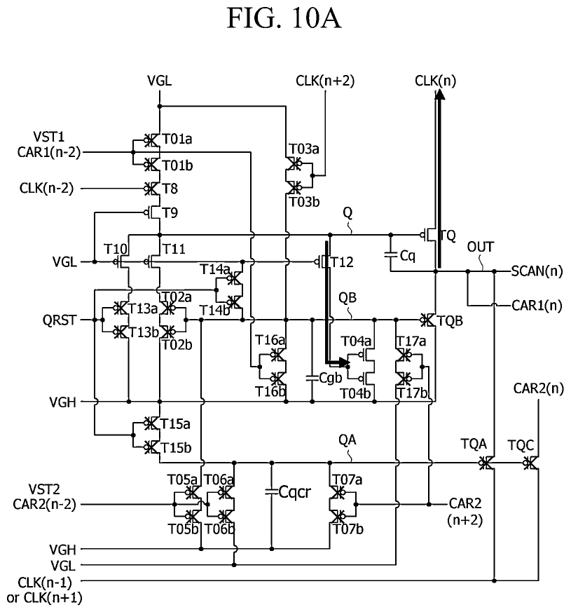

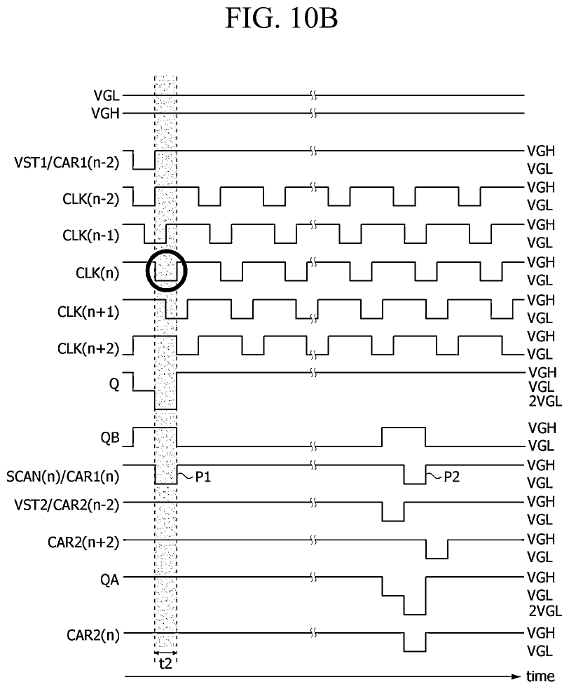

Referring to FIGS. 10A and 10B, the voltage of the n-th clock CLK(n) input to the first CLK node during a period t2 is the gate-on voltage VGL. In this situation, the voltage of the first control node Q is boosted by bootstrapping to a voltage 2VGL greater than the gate-on voltage VGL (e.g., 2×VGL), and the voltage of the output node OUT is charged to the gate-on voltage VGL so that the first pulse P1 of the scan signal SCAN(n) is output and simultaneously the pulse of the first carry signal CAR1(n) is output. During the period t2, the first and second switching transistors M1 and M2 and the driving transistor DR are turned on by the first pulse P1 of the scan signal SCAN applied to the pixel circuit shown in FIG. 2, and the pixel driving voltage VDD and the reference voltage Vref are applied to both ends, thereby maintaining the light-emitting element LD in an off state.

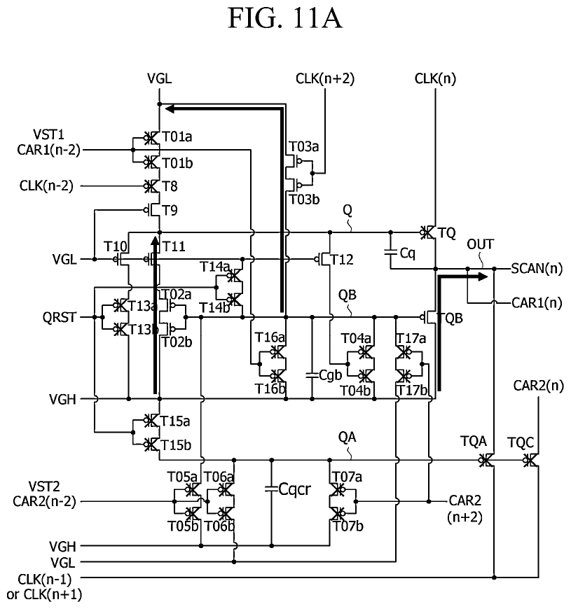

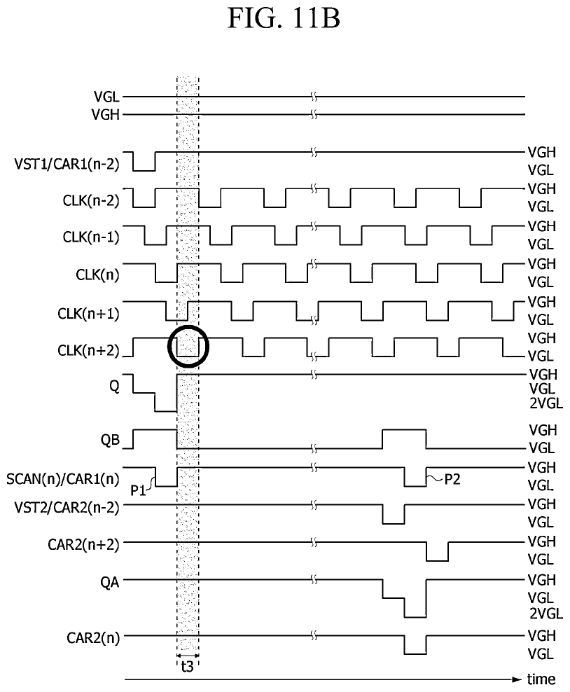

Referring to FIGS. 11A and 11B, the voltage of the (n+2)-th clock CLK(n+2) applied to the third CLK node during a period t3 is the gate-on voltage VGL. In this situation, the VGL node is electrically connected to the second control node QB so that the voltage of the second control node QB is charged to the gate-on voltage VGL, and the second transistors T02a and TO2b are turned on in response to the gate-on voltage VGL of the second control node QB so that the voltage of the first control node Q is discharged to the gate-off voltage VGH (e.g., transitions from 2VGL to VGH). During the period t3, the voltage of the scan signal SCAN applied to the pixel circuit shown in FIG. 2 is the gate-off voltage VGH. Therefore, during the period t3, the first and second switching transistors M1 and M2 of the pixel circuit are turned off, and a current flows through the channel of the driving transistor DR according to the gate-source voltage of the driving transistor DR so that the light-emitting element LD can emit light to be lit.

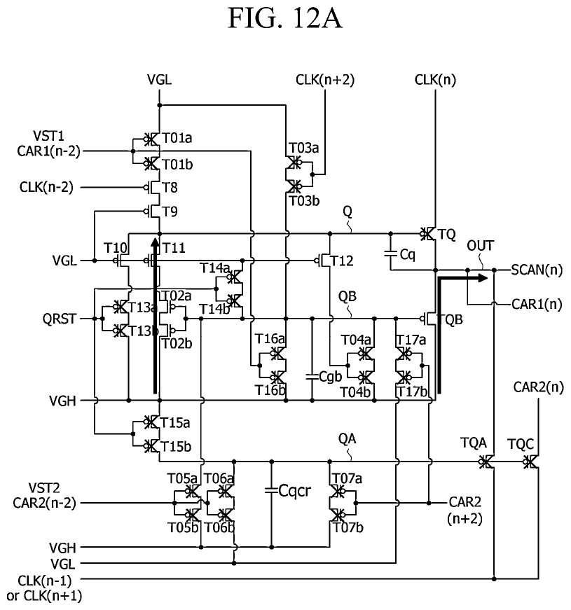

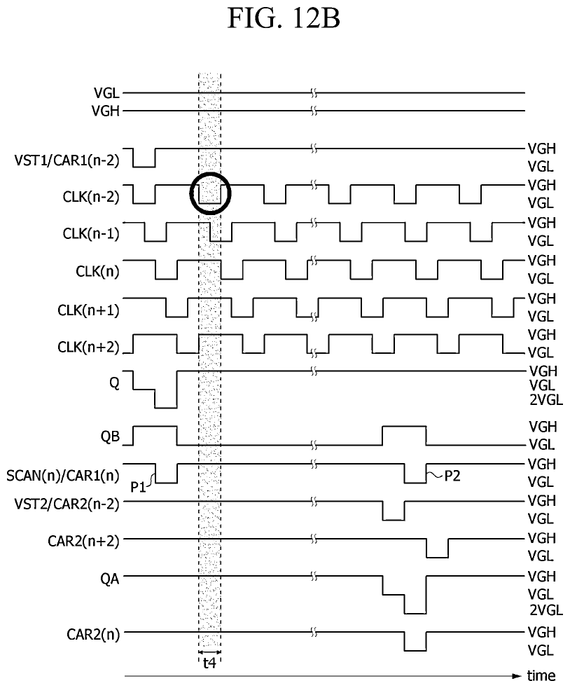

Referring to FIGS. 12A and 12B, the voltage of the n−2-th clock CLK(n−2) applied to the fourth CLK node during a period t4 is the gate-on voltage VGL. In this situation, the voltage of the second control node QB is maintained at the gate-on voltage VGL, and the voltage of the first control node Q is maintained at the gate-off voltage VGH. During the period t4, the voltage of the scan signal SCAN applied to the pixel circuit shown in FIG. 2 is the gate-off voltage VGH. Accordingly, during the period t4, the first and second switching transistors M1 and M2 of the pixel circuit are in the off state, and the light-emitting element LD can remain in the light-on state.

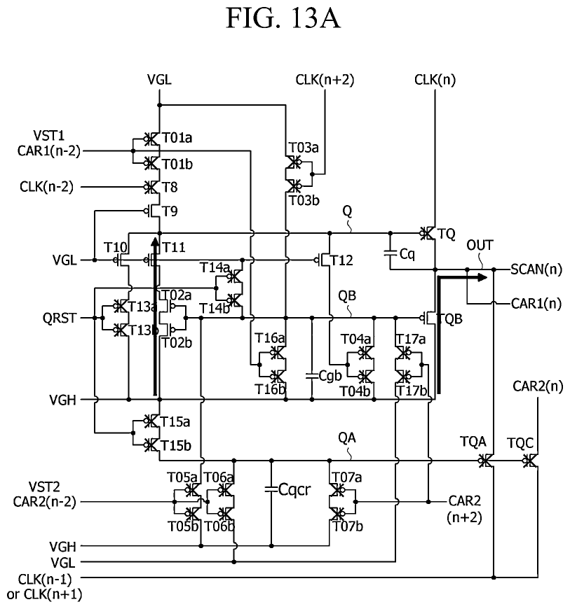

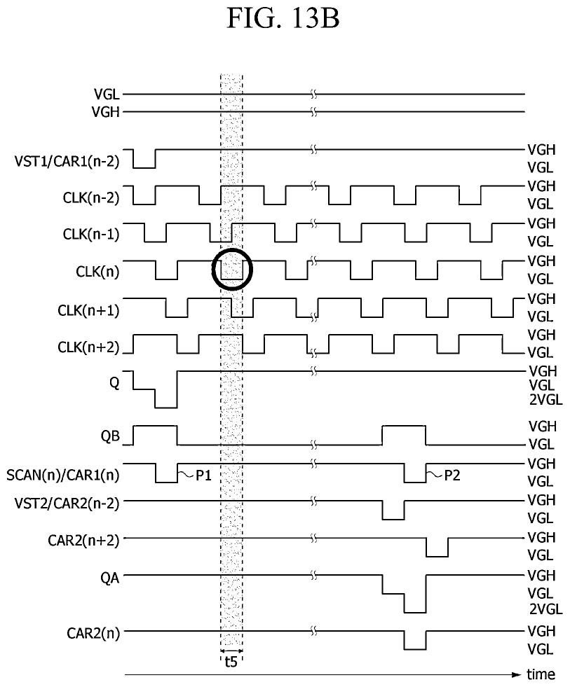

Referring to FIGS. 13A and 13B, the voltage of the n-th clock CLK(n) input to the first CLK node during a period t5 is again the gate-on voltage VGL. In this situation, the voltage of the second control node QB is maintained at the gate-on voltage VGL, and the voltage of the first control node Q is maintained at the gate-off voltage VGH. During the period t5, the voltage of the scan signal SCAN applied to the pixel circuit shown in FIG. 2 is the gate-off voltage VGH. Accordingly, during the period t5, the first and second switching transistors M1 and M2 of the pixel circuit are in the off state, and the light-emitting element LD can remain in the light-on state.

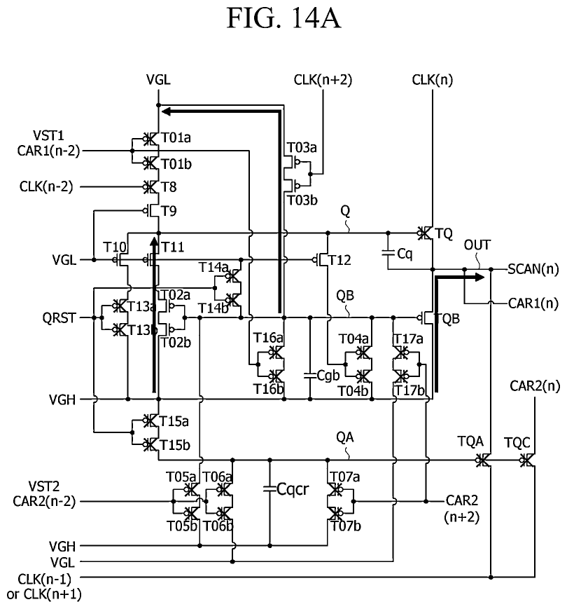

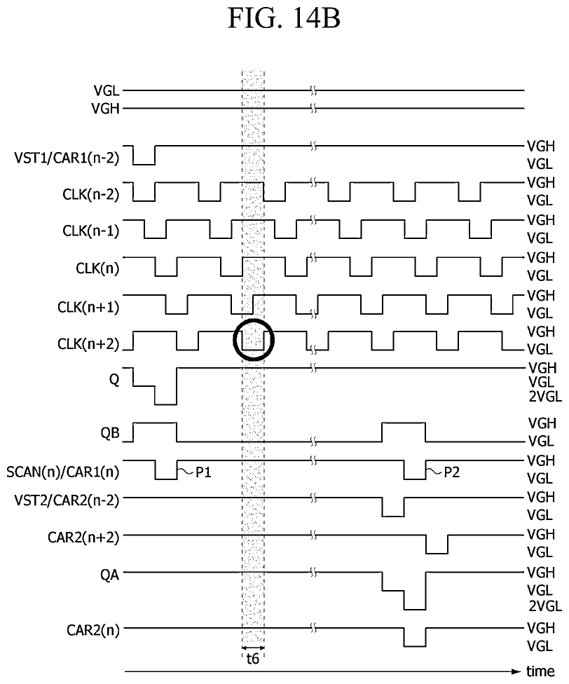

Referring to FIGS. 14A and 14B, the voltage of the n+2 clock CLK(n+2) input to the third CLK node during a period t6 is again the gate-on voltage VGL. In this situation, the voltage of the second control node QB is maintained at the gate-on voltage VGL, and the voltage of the first control node Q is maintained at the gate-off voltage VGH. During the period t6, the voltage of the scan signal SCAN applied to the pixel circuit shown in FIG. 2 is the gate-off voltage VGH. Accordingly, during the period t6, the first and second switching transistors M1 and M2 of the pixel circuit are in the off state, and the light-emitting element LD can still remain in the light-on state.

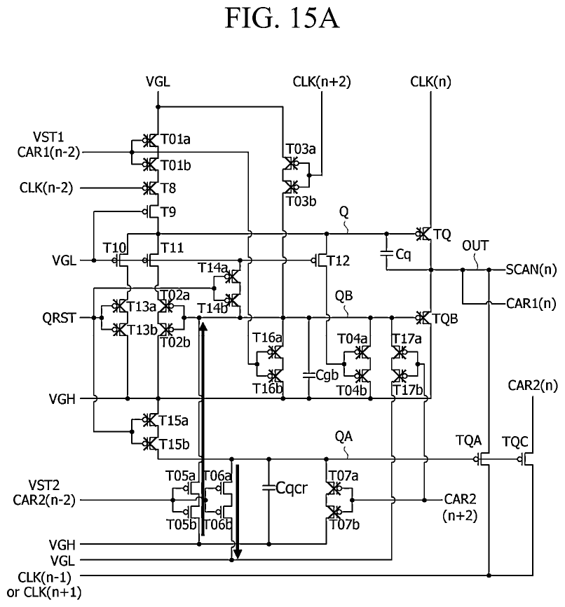

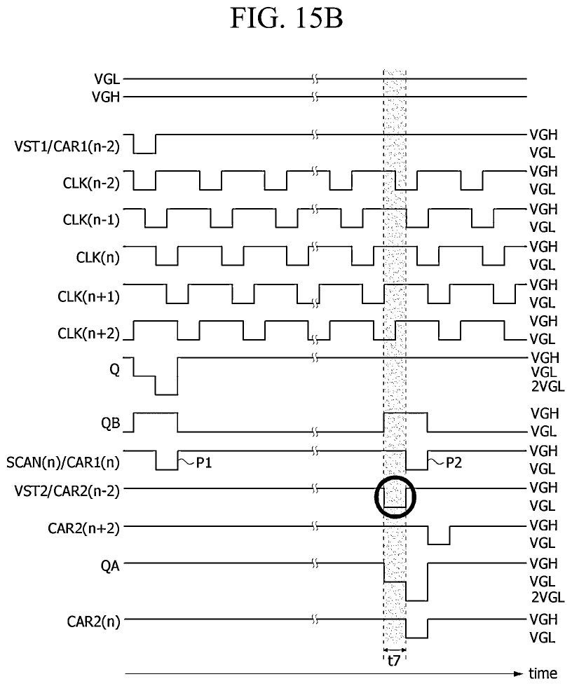

Referring to FIGS. 15A and 15B, the voltage of the second start signal VST2 input to the second VST node or the second carry signal CAR2(n−2) from the previous signal transfer part during a period t7 is the gate-on voltage VGL. In this situation, the fifth and sixth transistors TO5a to TO6b are turned on so that the voltage of the second control node QB is discharged to the gate-off voltage VGH, and the voltage of the third control node QA is charged to the gate-on voltage VGL. During the period t7, the voltage of the scan signal SCAN applied to the pixel circuit shown in FIG. 2 is the gate-off voltage VGH. Accordingly, during the period t7, the first and second switching transistors M1 and M2 of the pixel circuit are in the off state, and the light-emitting element LD can still remain in the light-on state.

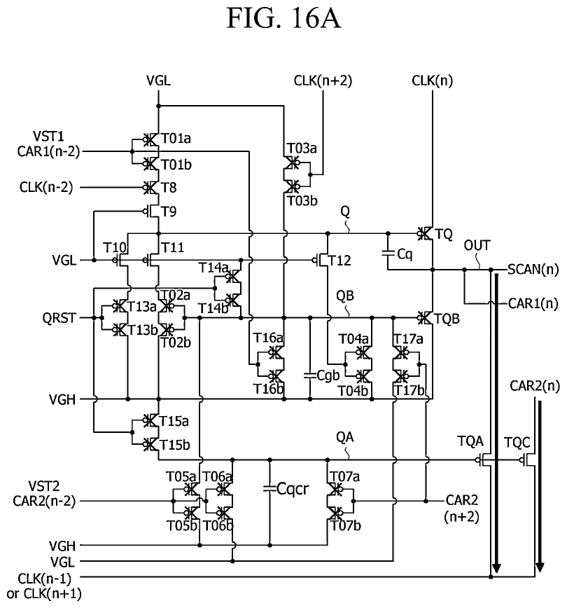

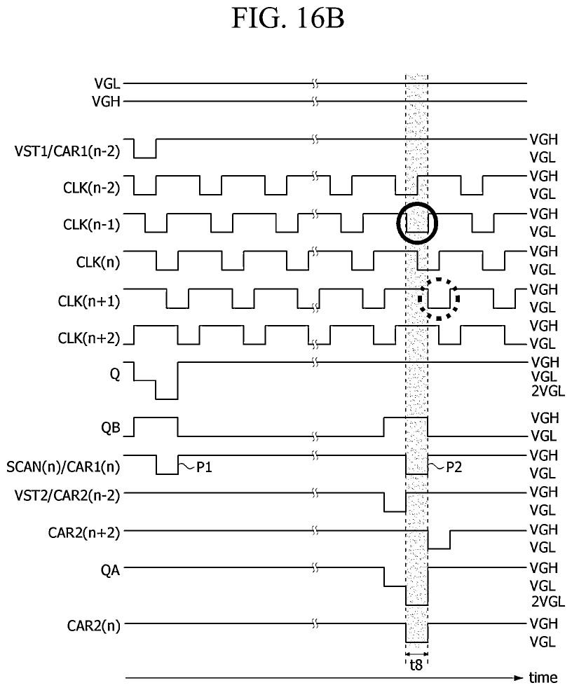

Referring to FIGS. 16A and 16B, the voltage of the (n−1)-th clock CLK(n−1) input to the second CLK node during a period t8 is the gate-on voltage VGL. In this situation, the voltage of the output node OUT is charged with the gate-on voltage VGL so that a second pulse of the scan signal SCAN and pulses of the first carry signal CAR1(n) and the second carry signal CAR2(n) can be output. During the period t8, the voltage of the scan signal SCAN applied to the pixel circuit shown in FIG. 2 is the gate-on voltage VGL. Accordingly, during the period t8, the first and second switching transistors M1 and M2 of the pixel circuit are turned on, and the black grayscale voltage BLK is applied to the first node DTG so that the driving transistor DR is turned off. In this situation, the light emitting element LD is light-off because it cannot emit light. For example, the light emitting element LD can emit light during periods t3 through t7, and the light emitting element LB is turned off during period t8.

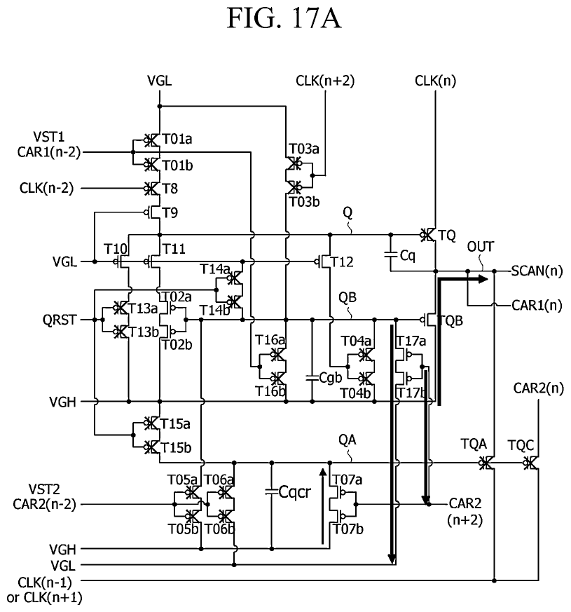

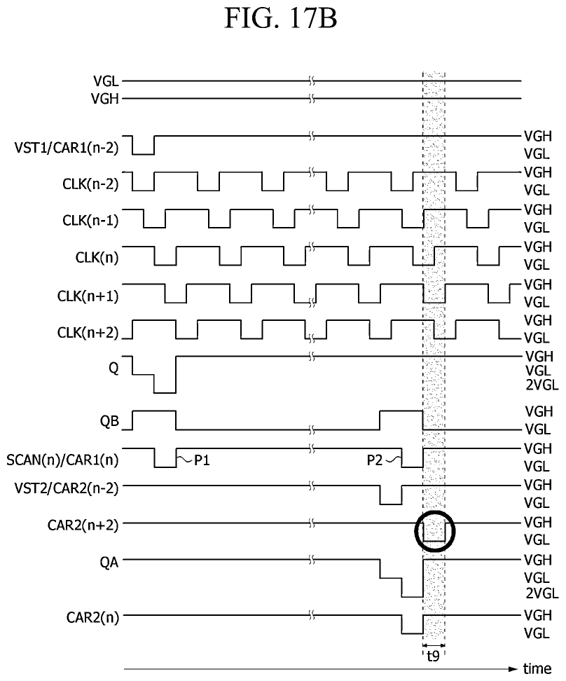

Referring to FIGS. 17A and 17B, the voltage of the n+2th carry signal CAR(n+2) input to the third CAR node during a period t9 is the gate-on voltage VGL. In this situation, the seventh and seventeenth transistors TO7a, TO7b, T17a, and T17b are turned on so that the voltage of the third control node QA is discharged to the gate-off voltage VGH, and the voltage of the second control node QB is charged to the gate-on voltage VGL During the period t9, the voltage of the first control node Q is maintained at the gate-off voltage VGH. Accordingly, during the period t9, the first and second switching transistors M1 and M2 of the pixel circuit are turned off, and the driving transistor DR is in the off state. In this situation, the light-emitting element LD remains in the light-off state.

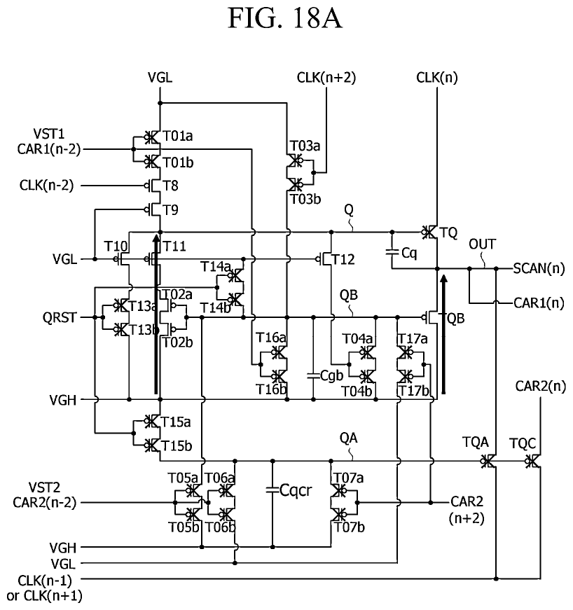

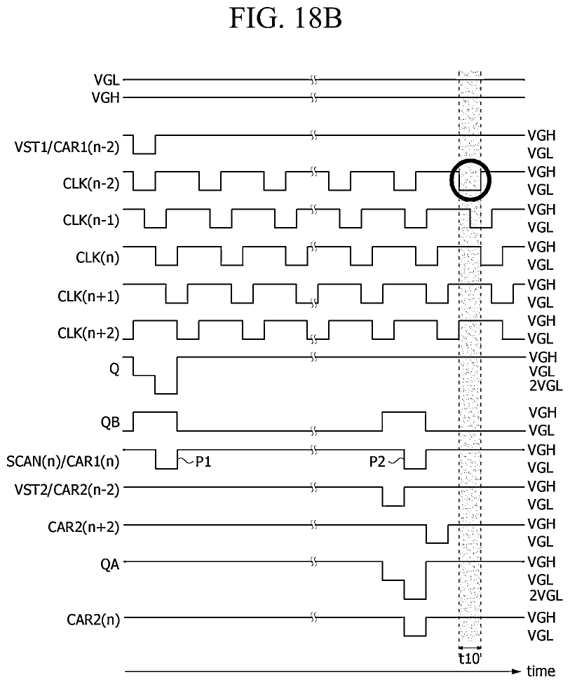

Referring to FIGS. 18A and 18B, the voltage of the n−2-th clock CLK(n−2) applied to the fourth CLK node during a period t10 is again the gate-on voltage VGL. In this situation, the voltage of the second control node QB is maintained at the gate-on voltage VGL, and the voltages of the first control node Q and third control node QA are maintained at the gate-off voltage VGH. During the period t10, the voltage of the scan signal SCAN applied to the pixel circuit shown in FIG. 2 is the gate-off voltage VGH. Accordingly, during the period t10, the first and second switching transistors M1 and M2 and the driving transistor DR of the pixel circuit are in an off state, and the light-emitting element LD remains in the light-off state.

In this way, the configuration of the gate driver can allow form a simplified or smaller sub-pixel circuit configuration that has a smaller footprint, which can allow for higher resolutions, while also being able to control the duty cycle of each sub-pixel. Also, the gate driver can adjust the ON duty cycle of each sub-pixel even when the sub-pixel is only connected to one scan line without having any additional emission control line, which can reduce wiring. For example, the gate driver can adjust the ON duty cycle of each sub-pixel based on the timing of two successive pulses on the same scan line. The sub-pixel is controlled to emit light during the time period between the two successive pulses on the same scan line. Thus, the farther apart the two successive scan pulses are from each other, then the corresponding sub-pixel stays on longer, and the closer together the two successive scan pulses are to each other, then the sub-pixel stays on for a shorter amount of time. In this way, a finer granularity of control can be provided even with a sub-pixel circuit that has a small footprint, which can also improve low power driving, prevent flicker, and extend the lifespan of the display device.

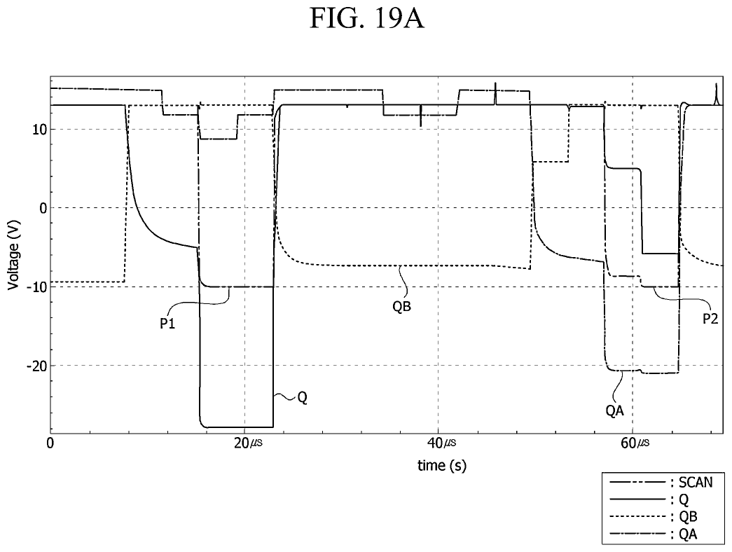

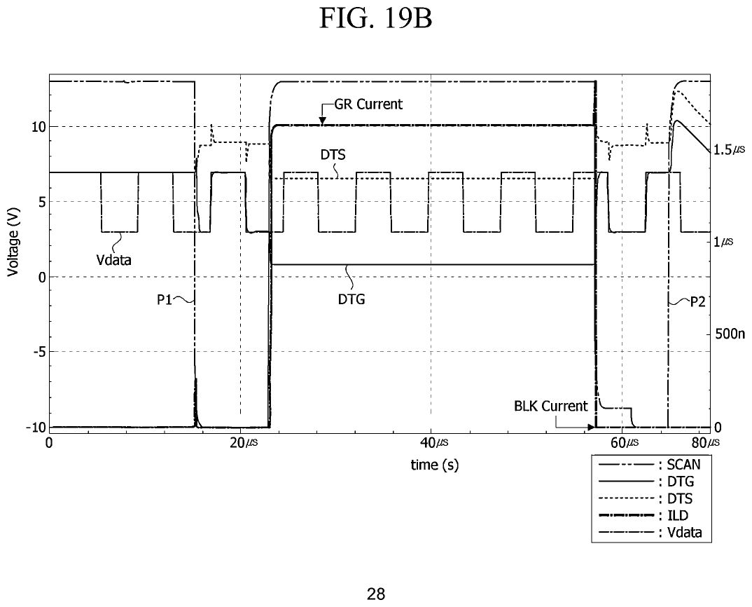

FIGS. 19A and 19B are diagrams illustrating simulation results for verifying the operation and effect of the signal transmission part shown in FIG. 8 according to an embodiment of the present disclosure.

Referring to FIGS. 19A and 19B, the first pulse P1 of the scan signal SCAN is synchronized with the pixel grayscale voltage GR of the data voltage Vdata so that the current corresponding to the grayscale value of the pixel data flows through the light-emitting element LD. The second pulse P2 of the scan signal SCAN is synchronized with the black grayscale voltage BLK of the data voltage Vdata so that no current flows to the light-emitting element LD. In FIG. 19B, “GR Current” is a current flowing in the light-emitting element LD, and ‘BLK Current’ is a current OA measured when the second pulse P2 of the scan signal SCAN is applied to the pixel circuit.

According to one or more embodiments of the present disclosure, the display device can be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc. Additionally, the display apparatus according to one or more embodiments of the present disclosure can be applied to organic light emitting lighting devices or inorganic light emitting lighting devices.

The objects to be achieved by the present disclosure, the means for achieving the objects, and effects of the present disclosure described above are examples, and thus, the scope of the claims is not limited to the disclosure of the present disclosure.

Although the embodiments of the present disclosure have been described in more detail with reference to the accompanying drawings, the present disclosure is not limited thereto and can be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

What is claimed is:

1. A gate driving circuit, comprising:
a first pulse output part configured to output a first pulse of a scan signal through an output node, and
a second pulse output part configured to output a second pulse of the scan signal through the output node,
wherein the first pulse output part includes:
a first output transistor having a gate electrode connected to a first control node; and
a second output transistor having a gate electrode connected to a second control node, and
wherein the second pulse output part includes:
a third control node; and
a third output transistor connected to the third control node, and
wherein the second pulse output part is connected to the second control node and the output node of the first pulse output part.

2. The gate driving circuit of claim 1, wherein the output node is configured to:
simultaneously output the first pulse of the scan signal and a first carry signal, and then output the second pulse of the scan signal simultaneously while a second carry signal is output through a second carry signal node.

3. The gate driving circuit of claim 2, wherein the first pulse output part further includes:
a first transistor connected between a gate-on voltage node and the first control node, and configured to be turned on in response to a gate-on voltage of a first start signal node;
a second transistor connected between a gate-off voltage node and the first control node, and configured to be turned on in response to a gate-on voltage of the second control node;
a third transistor connected between the gate-on voltage node and the second control node, and configured to be turned on in response to a gate-on voltage of a third clock node; and
a fourth transistor connected between the second control node and the gate-off voltage node, and configured to be turned on in response to a gate-on voltage of the first control node, and
wherein the first output transistor is connected between a first clock node and the output node, and configured to output a first pulse of the scan signal when a voltage of the first clock node is the gate-on voltage while the first control node is charged with the gate-on voltage,
wherein the second output transistor is connected between the output node and the gate-off voltage node, and configured to be turned on in response to a gate-on voltage of the second control node, and
wherein the first start signal node is configured to receive a first start signal or a first carry signal from a previous signal transmission part.

4. The gate driving circuit of claim 3, wherein the second pulse output part further includes:
a fifth transistor connected between the second control node and the gate-off voltage node, and configured to be turned on in response to a gate-on voltage of a second start signal node;
a sixth transistor connected between the third control node and the gate-on voltage node, and configured to be turned on in response to a gate-on voltage of the second start signal node;
a seventh transistor connected between the third control node and the gate-off voltage node, and configured to be turned on in response to a gate-on voltage of a third carry signal node; and
a fourth output transistor connected between the second carry signal node and a second clock node, and configured to be turned on in response to a gate-on voltage of the third control node to output a pulse of the second carry signal through the second carry signal node, and
wherein the third output transistor is connected between the second clock node and the output node, and configured to be turned on in response to a gate-on voltage of the third control node to output a second pulse of the scan signal,
wherein the second start signal node is configured to receive a second start signal or a second carry signal from the previous signal transmission part, and
wherein the third carry signal node is configured to receive a second carry signal from a next signal transmission part.

5. The gate driving circuit of claim 4, wherein the first pulse output part further includes:
an eighth transistor and a ninth transistor connected in series between the first transistor and the first control node;
a tenth transistor and a thirteenth transistor connected in series between the first control node and the gate-off voltage node;
an eleventh transistor connected between the first control node and the second transistor;
a twelfth transistor connected between the first control node and a gate electrode of the fourth transistor; and
a fourteenth transistor connected between the gate-on voltage node and the second control node.

6. The gate driving circuit of claim 5, wherein the eighth transistor is connected between the first transistor and the ninth transistor, and configured to be turned on in response to a gate-on voltage of a fourth clock node,
wherein the ninth transistor is connected between the eighth transistor and the first control node,
wherein each of the ninth transistor, the tenth transistor, the eleventh transistor, and the twelfth transistor are configured to be turned on in response to a gate-on voltage applied to the gate-on voltage node,
wherein the thirteenth transistor is connected between the tenth transistor and the gate-off voltage node, and configured to be turned on in response to a gate-on voltage of a reset signal node, and
wherein the fourteenth transistor is connected between the gate-on voltage node and the second control node, and configured to be turned on in response to a gate-on voltage of the reset signal node.

7. The gate driving circuit of claim 6, wherein the first pulse output part further includes:
a sixteenth transistor connected between the second control node and the gate-off voltage node, and configured to be turned on in response to a gate-on voltage of the first start signal node; and
a seventeenth transistor connected between the gate-on voltage node and the second control node, and configured to be turned on in response to a gate-on voltage of the third carry signal node.

8. The gate driving circuit of claim 7, wherein the second pulse output part further includes:
a fifteenth transistor connected between the gate-off voltage node and the third control node, and configured to be turned on in response to a gate-on voltage of the reset signal node.

9. A display device comprising:
a display panel including a plurality of data lines, a plurality of gate lines, and a plurality of pixel circuits;
a data driver configured to supply a pixel grayscale voltage and a black grayscale voltage to the plurality of data lines; and
a gate driver configured to supply a scan signal to the plurality of gate lines,
wherein the gate driver includes a plurality of signal transmission parts connected to a plurality of clock wires,
wherein an n-th signal transmission part among the plurality of signal transmission parts includes:
a first pulse output part configured to output a first pulse of the scan signal; and
a second pulse output part configured to output a second pulse of the scan signal,
wherein n is a natural number,
wherein each of the plurality of pixel circuits includes:
a driving transistor including a gate electrode connected to a first node, a first electrode connected to a second node, and a second electrode configured to receive a ground voltage;
a light-emitting element configured to emit light, the light-emitting element including an anode electrode configured to a pixel driving voltage, and a cathode electrode connected to the second node;
a first switching transistor connected between a data line among the plurality of data lines and the first node, and configured to be turned on in response to each of the first pulse of the scan signal and the second pulse of the scan signal;
a second switching transistor connected between a power line configured to receive a reference voltage and the second node, and configured to be turned on in response to each of the first pulse of the scan signal and the second pulse of the scan signal; and
a capacitor connected between the first node and the second node, and
wherein the first node is configured to receive the pixel grayscale voltage through the data line when the first pulse of the scan signal is input to the gate electrodes of the first and second switching transistors, and then receive the black grayscale voltage when the second pulse of the scan signal is input to the gate electrodes of the first and second switching transistors.

10. The display device of claim 9, wherein the first pulse output part includes an output node configured to simultaneously output the first pulse of the scan signal and a first carry signal through the output node, and then output the second pulse of the scan signal simultaneously while a second carry signal is output through a second carry signal node.

11. The display device of claim 10, wherein the first pulse output part includes:
a first transistor connected between a gate-on voltage node and a first control node, and configured to be turned on in response to a gate-on voltage of a first start signal node;
a second transistor connected between a gate-off voltage node and the first control node, and configured to be turned on in response to a gate-on voltage of a second control node;
a third transistor connected between the gate-on voltage node and a second control node, and configured to be turned on in response to a gate-on voltage of an (n+2)-th clock input to a third clock node;
a fourth transistor connected between the second control node and the gate-off voltage node, and configured to be turned on in response to a gate-on voltage of the first control node;
a first output transistor connected between a first clock node and the output node, and configured to be turned on when a voltage of a n-th clock input to the first clock node is a gate-on voltage while the first control node is charged with the gate-on voltage to output the first pulse of the scan signal; and
a second output transistor connected between the output node and the gate-off voltage node, and configured to be turned on in response to the gate-on voltage of the second control node; and
wherein the first start signal node is configured to receive a first start signal or a first carry signal from a previous signal transmission part.

12. The display device of claim 11, wherein the second pulse output part further includes:
a fifth transistor connected between the second control node and the gate-off voltage node, and configured to be turned on in response to a gate-on voltage of a second start signal node;
a sixth transistor connected between a third control node and the gate-on voltage node, and configured to be turned on in response to a gate-on voltage of the second start signal node;
a seventh transistor connected between the third control node and the gate-off voltage node, and configured to be turned on in response to a gate-on voltage of a third carry signal node;
a third output transistor connected between a second clock node and the output node, and configured to be turned on in response to the gate-on voltage of the third control node to output a second pulse of the scan signal by supplying a gate-on voltage of an (n−1)-th clock or an (n+1)-th clock input to the output node; and
a fourth output transistor connected between the second carry signal node and the second clock node, and configured to be turned on in response to a gate-on voltage of a third control node to output a pulse of a second carry signal through the second carry signal node,
wherein the second start signal node is configured to receive a second start signal or a second carry signal from the previous signal transmission part, and
wherein the third carry signal node is configured to receive a second carry signal from a next signal transmission part.

13. The display device of claim 12, wherein the first pulse output part further includes:
an eighth transistor connected between the first transistor and the first control node, and configured to be turned on in response to a gate-on voltage of a fourth clock node;
a ninth transistor connected between the eighth transistor and the first control node;
a tenth transistor connected between the first control node and the gate-off voltage node;
an eleventh transistor connected between the first control node and the gate-off voltage node;
a twelfth transistor connected between the first control node and a gate electrode of the fourth transistor;
a thirteenth transistor connected between the tenth transistor and the gate-off voltage node, and configured to be turned on in response to a gate-on voltage of a reset signal node;
a fourteenth transistor connected between the gate-on voltage node and the second control node, and configured to be turned on in response to a gate-on voltage of the reset signal node;
a sixteenth transistor connected between the second control node and the gate-off voltage node, and configured to be turned on in response to a gate-on voltage of the start signal node; and
a seventeenth transistor connected between the gate-on voltage node and the second control node, and configured to be turned on in response to a gate-on voltage of the third carry signal node, and
wherein each of the ninth transistor, the tenth transistor, the eleventh transistor, and the twelfth transistor is configured to turn on in response to a gate-on voltage applied to the gate-on voltage node.

14. The display device of claim 13, wherein the second pulse output part further includes:
a fifteenth transistor connected between the gate-off voltage node and the third control node, and configured to be turned on in response to a gate-on voltage of the reset signal node.

15. The display device of claim 13, wherein a voltage applied to the first node is changed from the black grayscale voltage to the pixel grayscale voltage during a first pulse width period of the scan signal, and
wherein the voltage applied to the first node is changed from the pixel grayscale voltage to the black grayscale voltage during a second pulse width period of the scan signal.

16. The display device of claim 9, wherein a difference between the pixel driving voltage and the reference voltage is smaller than a threshold voltage of the light-emitting element.

17. A display device comprising:
a display panel including a plurality of data lines, a plurality of gate lines, and at least one sub-pixel;
a data driver connected to the plurality of data lines, and configured to output a data voltage to a data line among the plurality of data lines that is connected to the at least one sub-pixel;
a gate driver connected to the plurality of gate lines, and configured to:
supply a first scan pulse and second scan pulse to a gate line among the plurality of gate lines that is connected to the at least one sub-pixel for causing the at least one sub-pixel to emit light based on the data voltage during a time period between the first scan pulse and the second scan pulse.

18. The display device of claim 17, wherein the gate driver is further configured to adjust a duty cycle of the at least one sub-pixel based on timings of the first scan pulse and the second scan pulse.

19. The display device of claim 17, wherein the at least one sub-pixel is only connected a single gate line among the plurality of gate lines, and the at least one sub-pixel is not connected to any emission control line.

20. The display device of claim 17, wherein the gate driver includes a plurality of gate driving circuits and at least one of the plurality of gate driving circuits includes:
a first pulse output part configured to output the first scan pulse through an output node, and
a second pulse output part configured to output the second scan pulse through the output node.

21. The display device of claim 20, wherein the first pulse output part includes:
a first output transistor having a gate electrode connected to a first control node; and
a second output transistor having a gate electrode connected to a second control node, and
wherein the second pulse output part includes:
a third control node; and
a third output transistor connected to the third control node, and
wherein the second pulse output part is connected to the second control node and the output node of the first pulse output part.
